(19) United States
(12) Patent Application Publication
(10) Pub. No.: US 2017/0193777 A1
(43) Pub. Date: Jul. 6, 2017

(54) ELECTRONIC ARTICLE SURVEILLANCE (EAS) ALARM TAG

(71) Applicant: USS Technologies, LLC, Rancho Cucamonga, CA (US)

(72) Inventors: Adel O. Sayegh, Rancho Cucamonga, CA (US); Anthony Oliver, Rancho Cucamonga, CA (US); Wenbin Yi, Hangzhou (CN); Cheng Jin, Hangzhou (CN); Guoqin He, Hangzhou (CN)

(21) Appl. No.: 14/988,384

(22) Filed: Jan. 5, 2016

(51) Int. Cl. G08B 13/24

(52) U.S. Cl. CPC G08B 13/2434; G08B 13/2465

(57) ABSTRACT

The present invention discloses a theft-deterrent tag that frictionally engages with an article, with the frictional engagement having sufficient strength to secure and maintain the tag engaged with the article while having a sufficiently loose hold where the tag is detached and removed from the article without damaging the article.

CROSS-REFERENCE TO RELATED APPLICATIONS

This Application claims the benefit of priority of the co-pending U.S. Utility Provisional Patent Application No. 62/100,005, filed Jan. 5, 2015, the entire disclosure of which is expressly incorporated by reference.

It should be noted that where a definition or use of a term in any incorporated document is inconsistent or contrary to the definition of that term provided herein, the definition of that term provided herein applies and the definition of that term in the incorporated document does not apply.

### BACKGROUND OF THE INVENTION

Field of the Invention

One or more embodiments of the present invention are related to loss prevention and Electronic Article Surveillance (EAS) and, more particularly, to EAS alarm tags that secure onto articles without damaging or permanently altering the articles, and allow the presence of the articles to be detected by compatible EAS equipment.

Description of Related Art

It is a common practice for retail stores to protect articles with EAS tags to prevent theft of the article by shoplifters. There are several methods of tagging articles or merchandise, most common of which is attaching an EAS tag or EAS labels using adhesive, pins, lanyards or straps to trigger the EAS security system resulting in an alarm. The EAS labels are easy to remove and the EAS tags with pins damage or permanently alter the article with which they are coupled. The cables or strapped EAS tags are sometimes bulky or obtrusive to the person trying on the protected merchandise like a pair of shoes or boots to determine the fit. This makes the trying on process inconvenient and ineffective. In other words, for most instances, the EAS tag must be removed by an authorized person before a buyer can try on the article. Further to this, most conventional cables or straps used to attach the conventional tag to the merchandise can be cut which then makes it easy for shoplifters to remove these tags, rendering the article unsecure and unprotected.

Other methods of tagging an article include the use of EAS tags that are capable of frictionally engaging articles using a tight grip mechanism, which prevents unauthorized removal of the tag from the article. However, it has been found that the strong, tight grip of such EAS tags for frictionally engagement with articles (especially soft articles such as soft leather articles) damages the surface of the article by leaving a permanent imprint or mark of the gripping surface of the grip mechanism on the article's surface. Of course, loosening the tight grip of the EAS tags with the articles would obviate the imprint or marking problem, but the article would not be protected as the EAS tag could be easily detached and removed from the article, leaving the article unprotected.

There remains a long standing and continuing need for an advance in the art of EAS and theft deterrent tags that makes the tags more difficult to defeat, simpler in both design and use, more economical and efficient in their construction and use, and provide a more secure and reliable engagement of the article to be monitored without damaging or permanently altering the article.

### BRIEF SUMMARY OF THE INVENTION

A non-limiting, exemplary aspect of an embodiment of the present invention provides a theft-deterrent tag, comprising:

a housing that frictionally engages with an article;

with the frictional engagement having sufficient strength to secure and maintain the housing engaged with the article while having a sufficiently loose hold where the housing is detached and removed from the article without damaging the article.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 1C are non-limiting, exemplary illustration of various views of an EAS alarm tag associated with an article of clothing in accordance with one or more embodiments of the present invention;

FIGS. 2A to 2I are non-limiting, exemplary illustrations of various views of the EAS alarm tag shown in FIGS. A to 1C in accordance with one or more embodiments of the present invention;

FIGS. 3A to 3L are non-limiting, exemplary illustrations of various views of EAS alarm tag as shown in FIGS. 1A to 2I in accordance with one or more embodiments of the present invention, illustrating first and second members of the housing;

FIGS. 4A to 4C-2 are non-limiting, exemplary illustrations of various views of a retainer in accordance with one or more embodiments of the present invention;

FIGS. 4D to 4P are non-limiting, exemplary illustrations of an EAS tag detailing a lock mechanism in accordance with an embodiment of the present invention;

FIGS. 5A to 5C are non-limiting, exemplary illustrations of an EAS alarm circuitry in accordance with one or more embodiments of the present invention;

FIGS. 6A to 6G are non-limiting, exemplary illustration of flowcharts, which amongst other aspects, also illustrate a power management and functionality of a microcontroller unit (MCU) for EAS alarm tag;

FIGS. 7A to 7J are non-limiting, exemplary illustrations of an EAS alarm tag in accordance with one or more embodiments of the present invention;

FIGS. 8A to 8I are non-limiting, exemplary illustrations of an EAS alarm tag in accordance with one or more embodiments of the present invention; and

FIGS. 9A to 9I are non-limiting, exemplary illustrations of an EAS alarm tag in accordance with one or more embodiments of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by data processor(s) of computers. Further, each block within a flowchart (if a flowchart is used) may represent both method function(s), operation(s), or act(s) and one or more elements for performing the method function(s), operation(s), or act(s). In addition, depending upon the implementation, the corresponding one or more elements may be configured in hardware, software, firmware, or combinations thereof

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

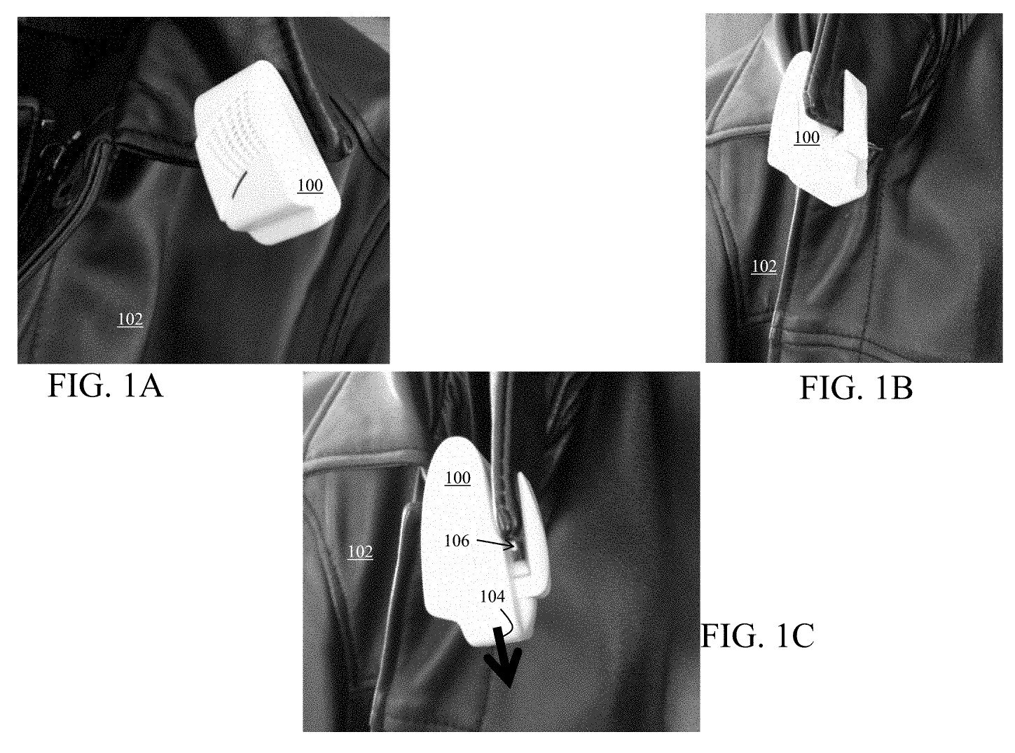

FIGS. 1A to 1C are non-limiting, exemplary illustration of various views of an EAS alarm tag associated with an article of clothing (such as a soft leather jacket) in accordance with one or more embodiments of the present invention. As illustrated, one or more embodiments of the present invention provide a small and compact EAS alarm tag 100 that is secured onto an article 102 by a sufficient frictional engagement strength while preventing damage to the engaging surface of article 102. The frictional engagement of EAS alarm tag 100 with article 102 secured within gap 106 no longer leaves a permanent imprint or mark of the gripping surface of EAS alarm tag 100 onto the engaging surface of article 102. Further, while secure on article 102, the frictional engagement of EAS alarm tag 100 with article 102 also enables detachment and removal of EAS alarm tag 100 from article 102 with or without proper authorization to prevent damage to article 102 as EAS alarm tag 100 is removed along the direction indicated by arrow 104 shown in FIG. 1C. That is, EAS alarm tag 100 may be detached and removed by pulling tag 100 in the direction as shown by arrow 104 from article 102 without it being neutralized for proper disengagement and still not damage article 102. However, since EAS alarm tag 100 includes one or more internal alarms, unauthorized detachment and removal of EAS alarm tag 100 from article 102 would trigger one or more of the internal alarms of EAS alarm tag 100. Accordingly, the present invention provides EAS alarm tag 100 that engages with article 102 and is secured with sufficient strength to prevent damage, and includes an internal alarm in case EAS alarm tag 100 is detached from article 102 without authorization or use of proper disengaging device, non-limiting example of which may be a magnetic detaching mechanism.

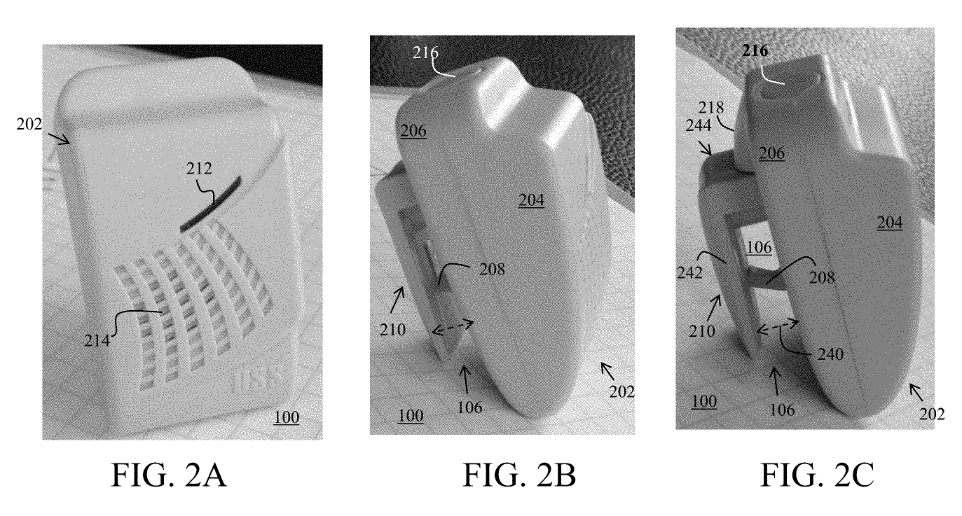

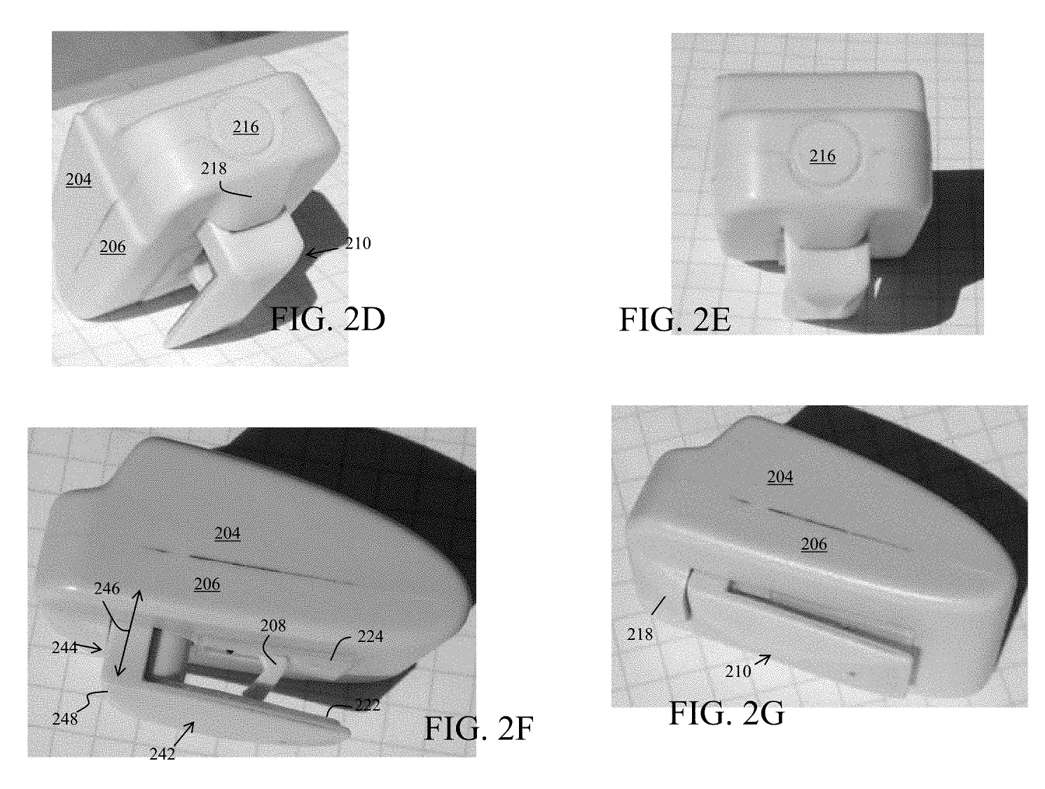

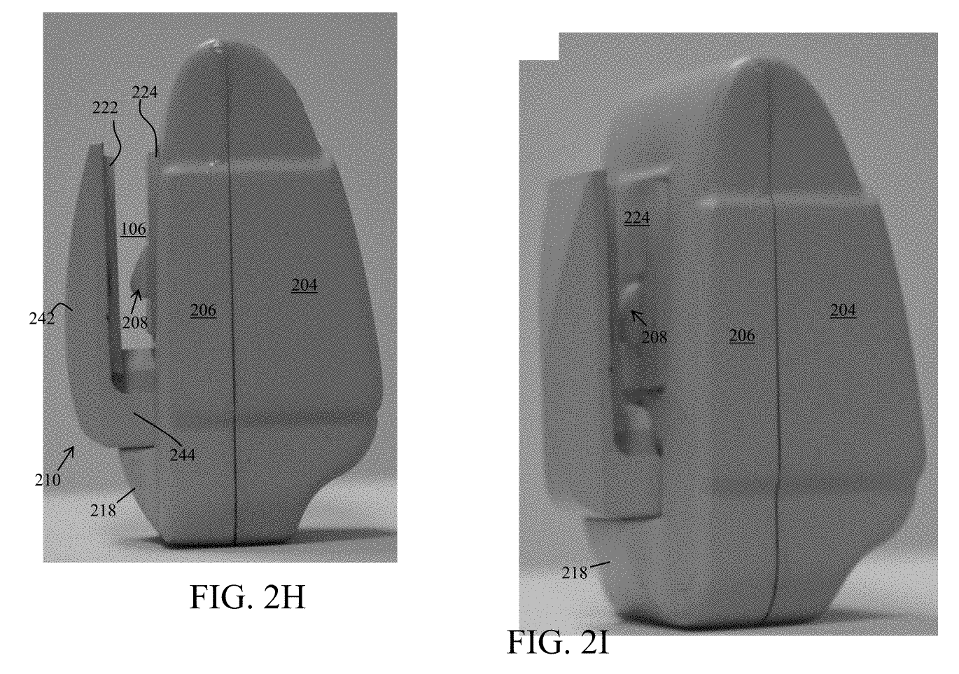

FIGS. 2A to 2I are non-limiting, exemplary illustrations of various views of the EAS alarm tag shown in FIGS. A to 1C in accordance with one or more embodiments of the present invention. As illustrated, EAS alarm tag 100 includes a housing 202 with a retainer 210 associated with housing 202 and movable to an engagement position to frictionally grip and hold EAS alarm tag 100 on article 102 while an actuator 208 arms an internal alarm system. The frictional hold of retainer 210 has sufficient strength to secure and maintain EAS alarm tag 100 on article 102 while having a sufficiently loose grip where EAS alarm tag 100 is easily detached and removed from article 102 with a pull on tag 100 without damaging article 102.

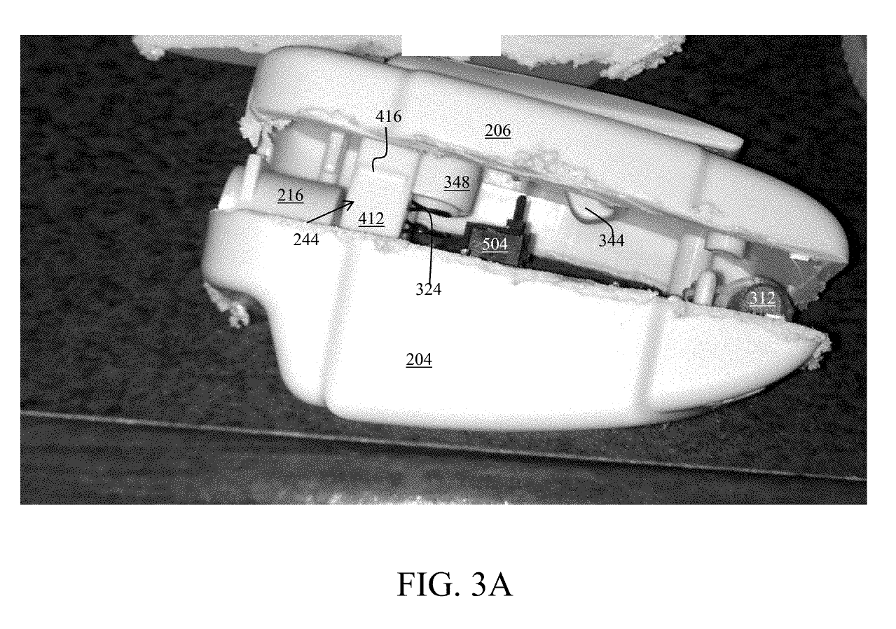

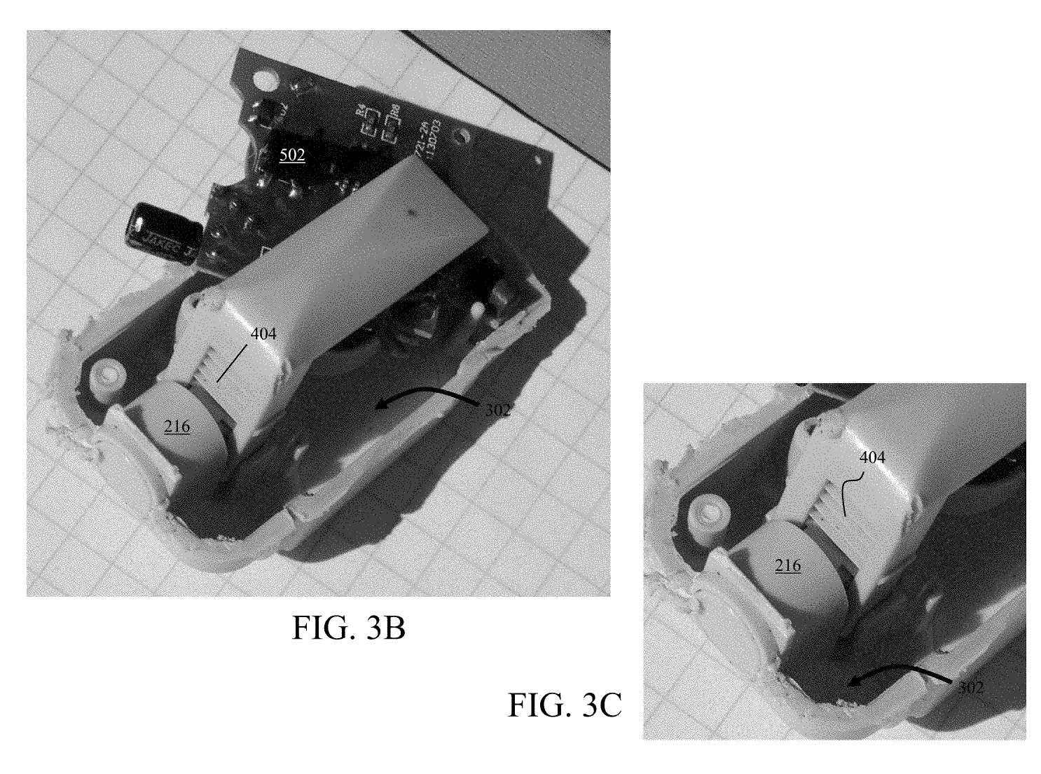

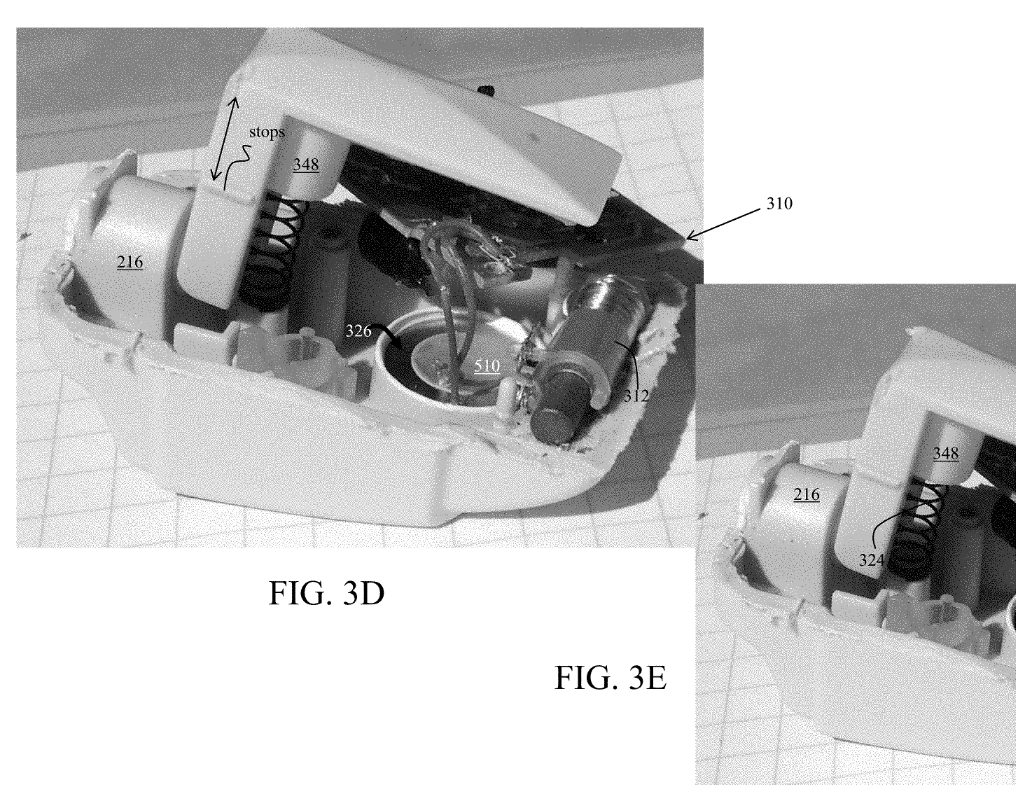

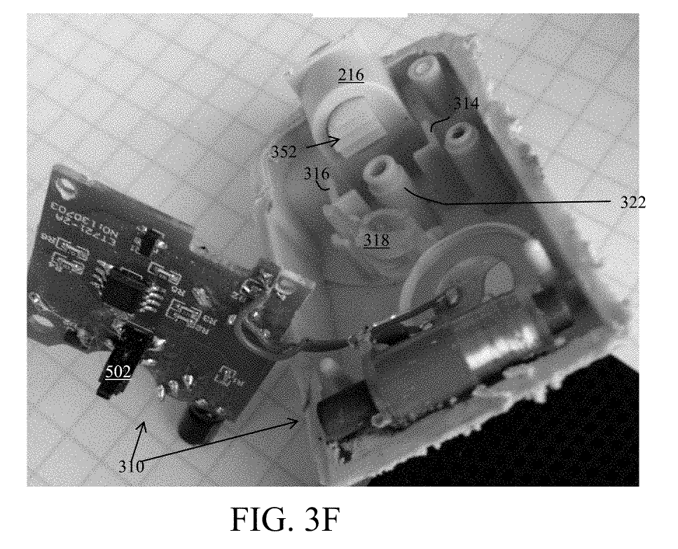

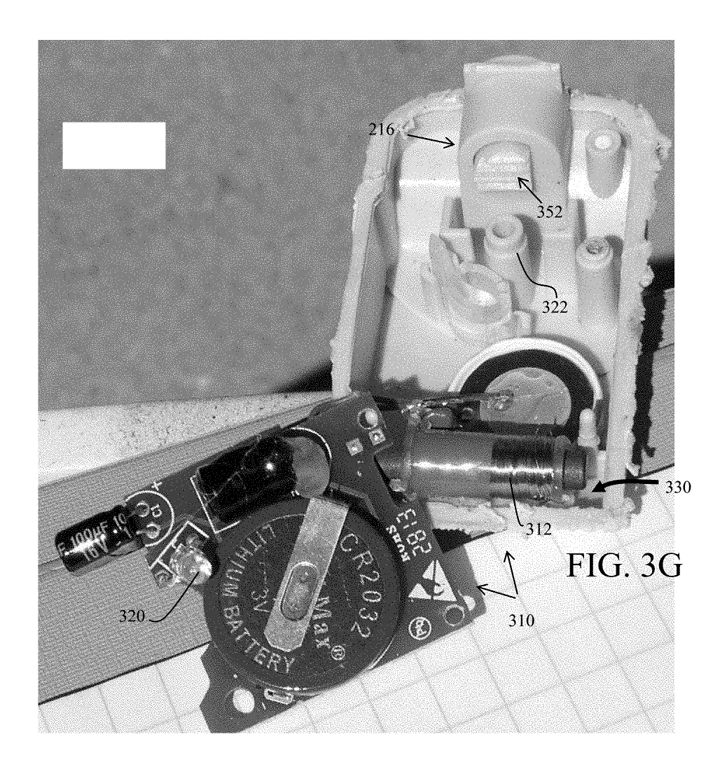

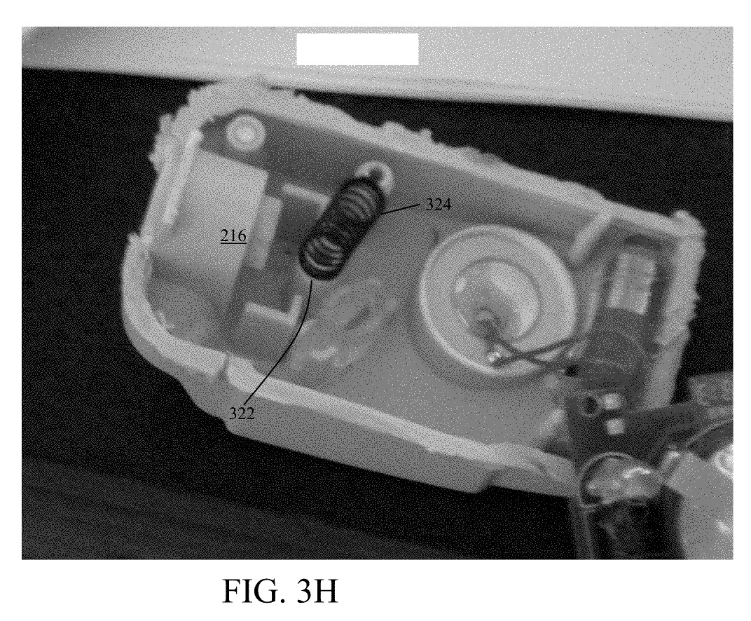

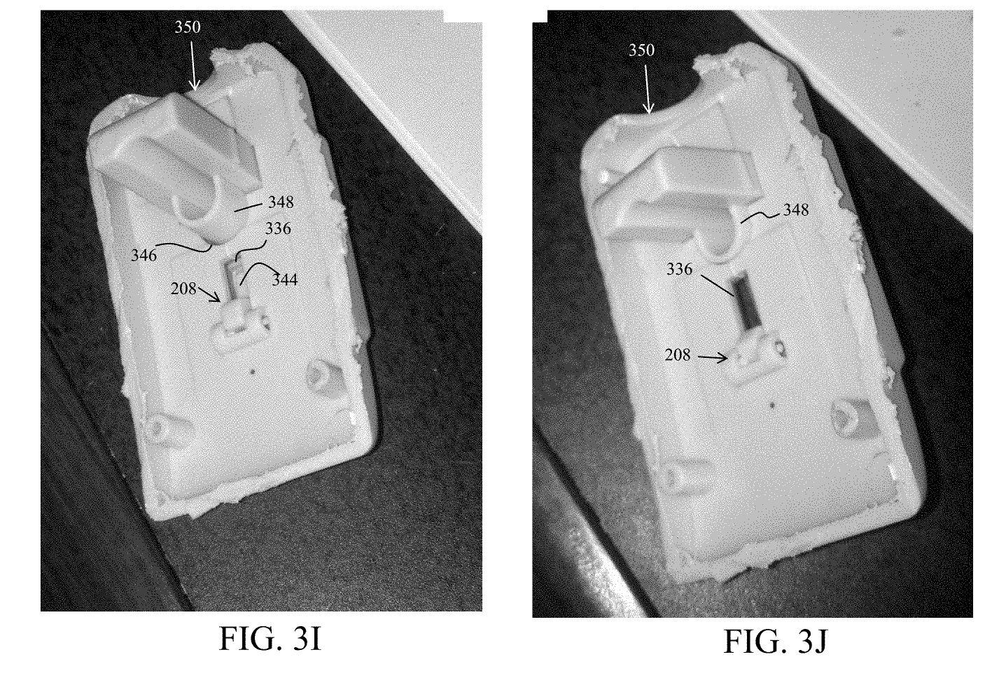

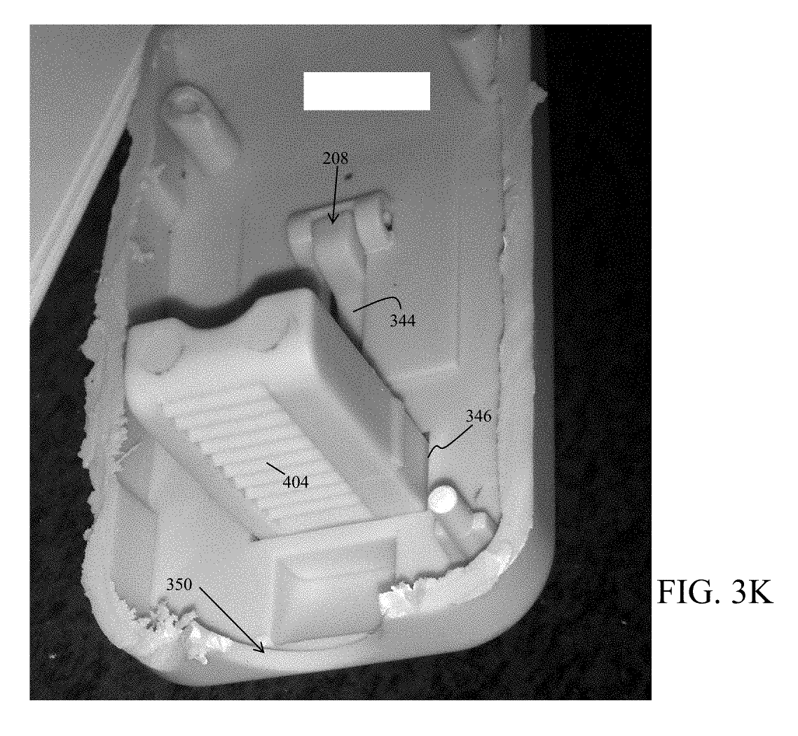

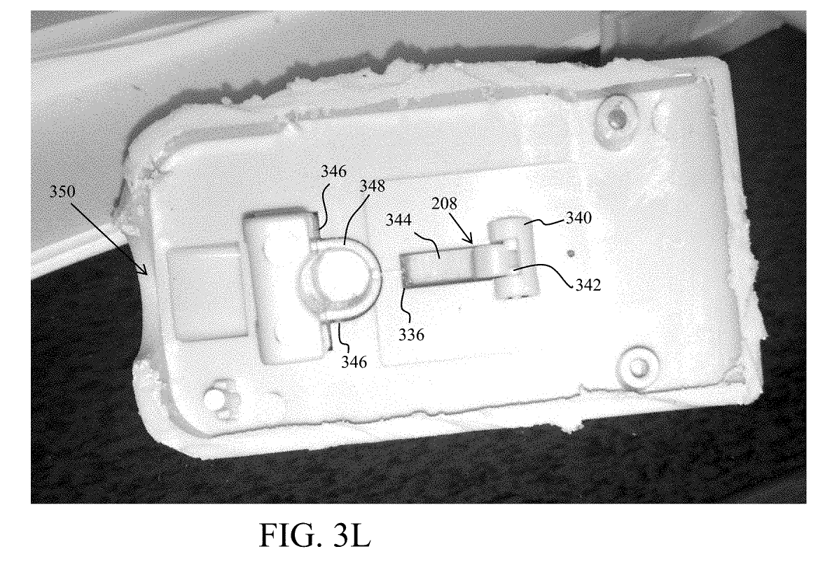

As further detailed below, EAS alarm tag 100 includes EAS module 310 (FIG. 3D) that is accommodated within housing 202. EAS module 310 triggers an alarm when EAS alarm tag 100 is detached and removed from article 102 while EAS module 310 is armed. Retainer 210 activates EAS module 310 when moved to an engagement position to grip and frictionally hold onto article 102. That is, when article 102 is inserted within gap 106, it presses against and moves an actuator 208 to a closed position to actuate an alarm switch 504 (detailed below), which, in turn, arms EAS module 310. Compressing retainer 210 to engagement position further pushes article 102 against actuator 208 while gripping and frictionally holding article 102.

As further illustrated, retainer 210 and housing 202 form gap 106 between which article 102 is inserted, with a size of gap 106 varied by the moving position of retainer 210 to engage article 102. Retainer 210 is comprised of a throw section 244 and a span section 242. Throw section 244 is substantially transverse span section 242, with span section 242 substantially parallel housing 202 (which means that throw section 244 is substantially perpendicular to housing 202). Span section 242 is moved towards and away from housing 202 as a result of a portion of throw section 244 movably extending in and out of housing 202 along a linear reciprocating path 246 (FIG. 2F), allowing span section 242 of retainer 210 to move closer or further away from housing 202 to reduce or increase an extent 240 (FIG. 2C) of gap 106 between span section 242 of retainer 210 and housing 202 for a secure hold on article 102.

FIGS. 3A to 3L are non-limiting, exemplary illustrations of various views of EAS alarm tag as shown in FIGS. 1A to 2I in accordance with one or more embodiments of the present invention, illustrating first and second members of the housing. As illustrated, housing 202 is comprised of a first member 204 and a second member 206 that are coupled (e.g., using ultrasonic welding) to form housing 202. First member 204 includes a perforated area that forms grill-openings 214 for facilitating an output of an audio indicator sound. First member 204 also includes a visual indicator aperture 212 for viewing of visual indicator device. Additionally, first member 204 includes a cavity 302 that accommodates EAS module 310, including a marker 312. Cavity 302 of first member 204 further includes a set of guide structures 314 and 316 (FIG. 3F) that substantially align throw-section 244 of retainer 210 to perpendicularly extend in and out of housing 202 to maintain an orientation of throw-section 244 while being moved. Cavity 302 also includes a visual indicator compartment 318 that secures an LED 320 within housing 202, and a biasing support 322 (FIG. 3C) configured as a cylindrical pole that maintains a mounted resilient member 324 thereon. Cavity 302 of first member 204 also includes a transducer compartment 326 that is configured to securely house an audio transducer 510, and also includes marker section 330 that secures marker 312 within housing 202 in addition to a lock mechanism housing 216.

Lock mechanism housing 216 houses a well-known locking mechanism, the structure, function, and operation of which is similar to that which is disclosed in the U.S. Pat. No. 7,808,386 to Sayegh, et al., and the entire disclosure of which is incorporated by reference in its entirety herein. In general, lock mechanism is comprised of an engaging member that has a base and an engaging portion extending from the base, a surface of which is serrated, with the base having a larger cross-sectional profile than the engaging portion. The lock mechanism further includes a locking resilient member that is housed within a bore of the base. An exterior surface of the base presses against a first wall of the locking mechanism housing, allowing the engaging portion to extend out of an opening of the first wall of the locking mechanism housing. A second wall of the locking mechanism housing, opposite the first wall enables the resilient member to press against the second wall.

As further illustrated in FIGS. 3A to 3L, housing 202 further includes second member 206 which has an actuator aperture 336 (FIG. 3J) that enables an actuator arm 344 of actuator 208 to pass through and a hinge barrel 340 (FIG. 3L) for coupling a hinge pin 342 of actuator 208. Second member 206 includes a retainer aperture 346 configured commensurate with the profile portion of throw section 244 that includes a chamber 348 (detailed below) for biasing mechanism 324. A concaved curved cut-out section 350 at a side of second member 206 is used for accommodating lock mechanism housing 332 for when mating with first member 204.

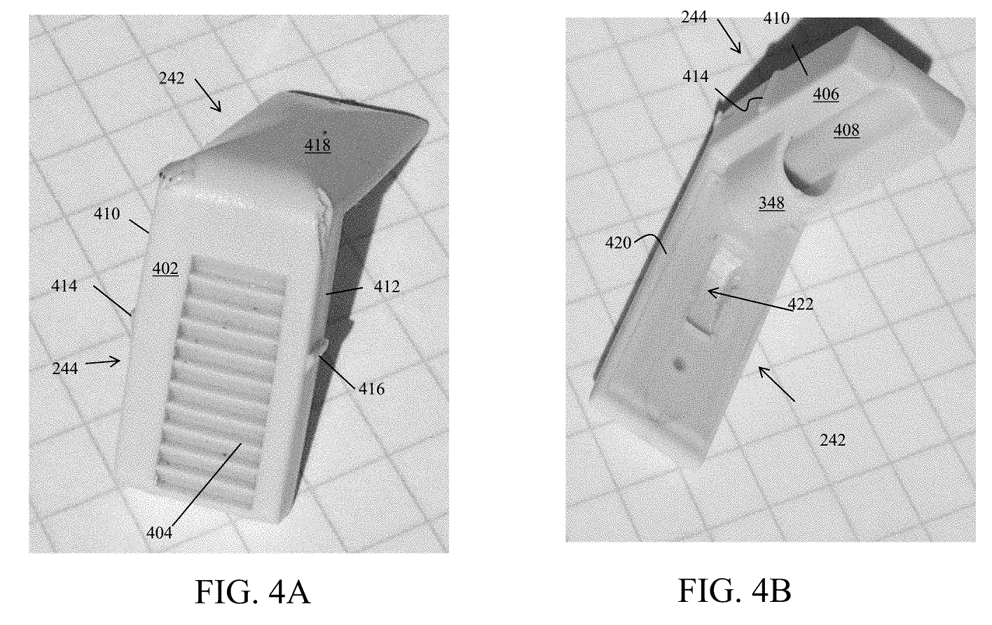

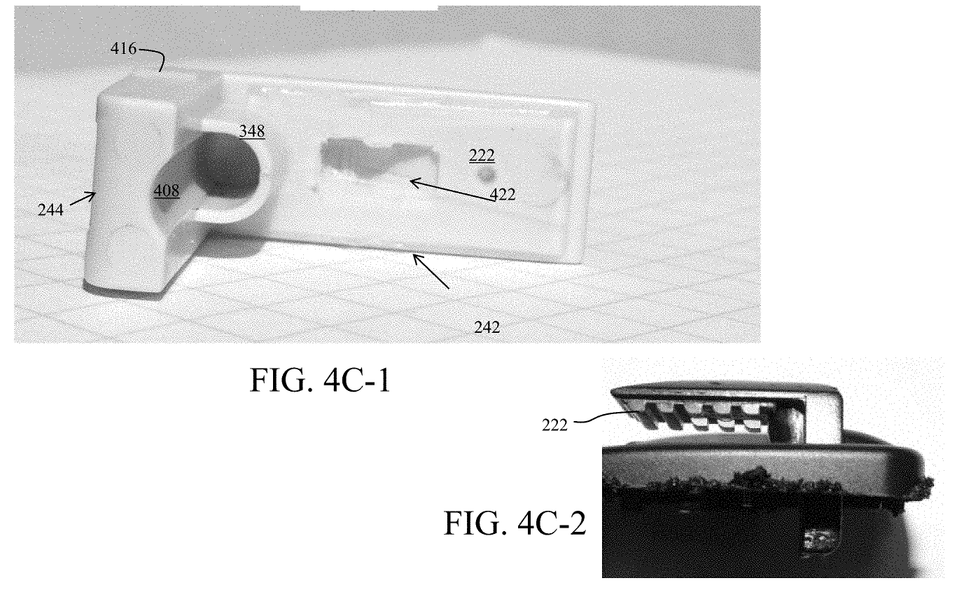

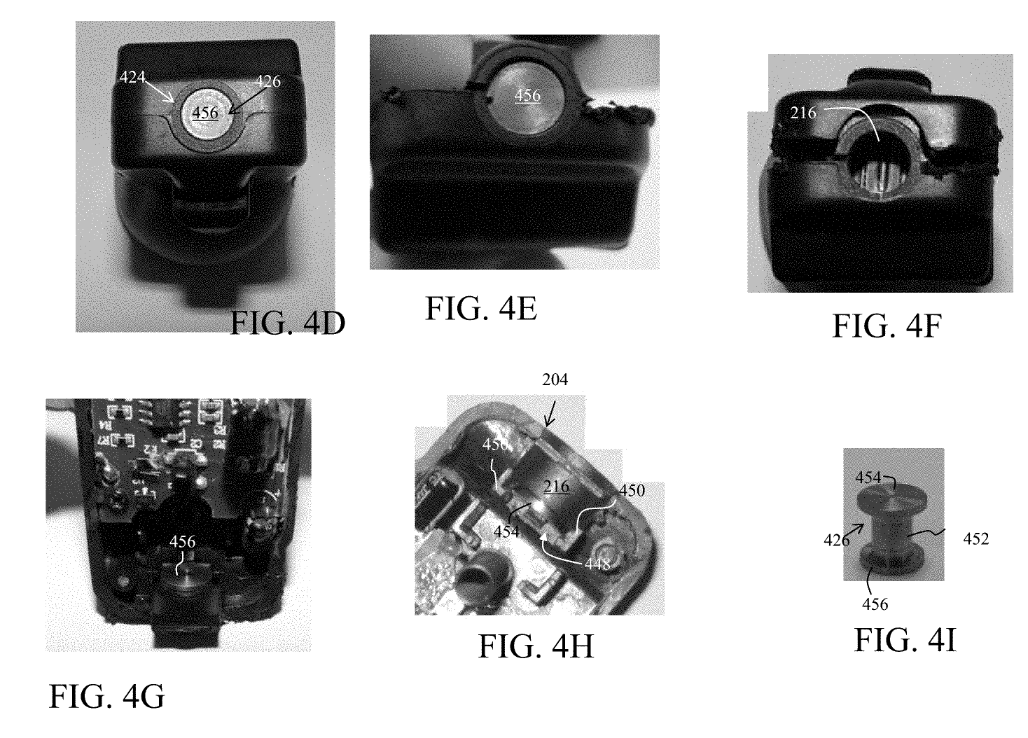

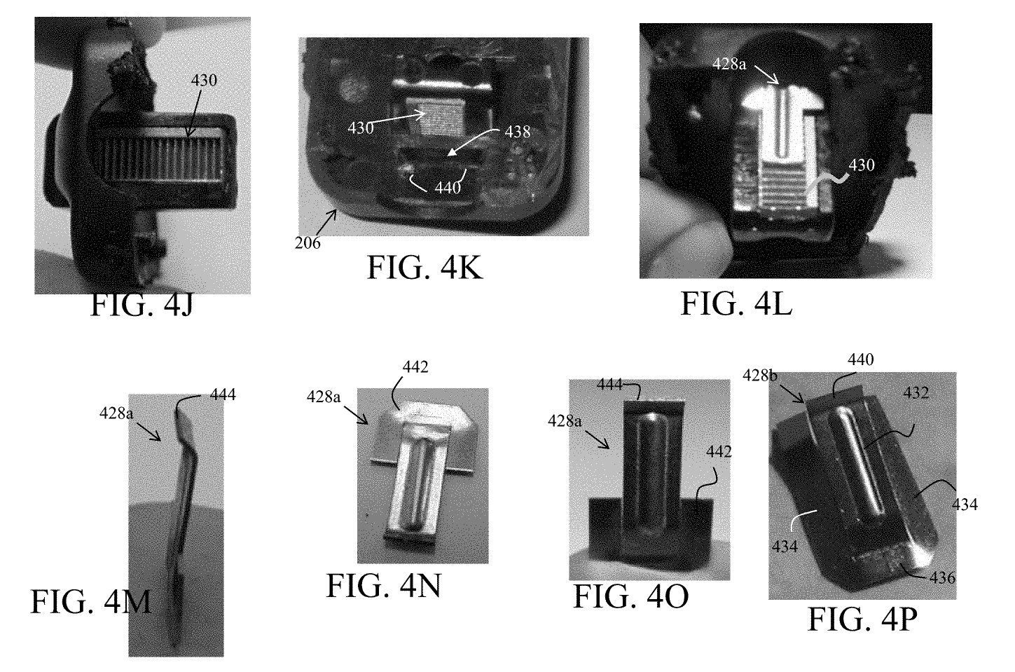

FIGS. 4A to 4C-2 are non-limiting, exemplary illustrations of various views of a retainer in accordance with one or more embodiments of the present invention. As illustrated, retainer 210 is comprised of throw section 244 and span section 242, with throw section 244 comprised of a first side 402 that includes a first set of serrations 404 that engage a second set of serrations 352 of a lock mechanism 332 to maintain the position of retainer 210 against forces of resilient member 324 of the lock mechanism.

A second side 406 of the throw section 244 includes chamber 348 that partially house resilient member 324 and further, includes a groove 408 extending along a central longitudinal axis of a surface of second side 406 for accommodating the remaining portion of resilient member 324 and allowing resilient member 324 to rest against while retainer 210 is articulated. Throw section 244 further includes a first and a second lateral surface 410 and 412 that include flanges 414 and 416 that form stops for preventing retainer 210 from completely moving out of housing 202 as a result of the force of resilient member 324.

Span section 242 of retainer 210 is comprised of a first side 418 and a second side 420, with second side 420 including a cavity 422 that accommodates actuator arm 344 of actuator 208 for preventing activation of EAS module 310 when no article 102 is present and retainer 210 is at the hold or engagement position. Second side 420 of span section 242 also includes padding 222 (aligned with a padding 224 of second member 206) for improved grip of retainer 210 and added cushion for preventing damage to article 102. Both padding 222 and 224 have a through-hole for allowing passage of actuator arm 344 to be accommodated within cavity 422 of second side 420 of span section 244 when no article 102 is present and retainer 210 is at hold or engagement position. Accordingly, cavity 422 prevents arming of EAS module 310 even if retainer 210 is moved to engagement position if there is no article 102 within gap 106. Stated otherwise, EAS alarm tag 100 does not arm if there is no article 102 secured within gap 106, which save battery power. That is, when there is no article 102 within gap 106, then nothing blocks access to cavity 422 from accommodating actuator 208. In other words, as retainer 210 is moved to engagement position, actuator 208 is freely moved inside cavity 422 without being able to exert a force to actuate alarm switch 504 to arm EAS module 310. It should be noted that the padding 222 need not be flat, but may comprise of serrations as illustrated in FIG. 4C-2.

A first distal end of span section 242 and a first distal end of the throw section 244 form a bend 248 of the retainer, with a second distal end of the span section 242 and the second distal end of the throw 244 section free. The second distal end of the throw section 244 is accommodate within housing 202, through a first opening and is aligned to substantially perpendicularly extend in and out of the housing by set of guide structures 314 and 316. It should be noted that when retainer 210 is in a fully engaged position it becomes flush with a protruded hump section 218 (FIG. 2D) of second member 206 of EAS alarm tag 100, which prevents access to serrations 404 by a prying tool to defeat EAS alarm tag 100.

FIGS. 4D to 4P are non-limiting, exemplary illustrations of an EAS tag with a different type of lock mechanism in accordance with an embodiment of the present invention. The EAS tag illustrated in FIGS. 4D to 4P includes similar corresponding or equivalent components, interconnections, functional, operational, and or cooperative relationships as the EAS tag that is shown in FIGS. 1A to 4C, and described above. Therefore, for the sake of brevity, clarity, convenience, and to avoid duplication, the general description of FIGS. 4A to 4P will not repeat every corresponding or equivalent component, interconnections, functional, operational, and or cooperative relationships that has already been described above in relation to the EAS tag that is shown in FIGS. 1A to 4C.

As illustrated in FIG. 4D to 4P, EAS tag 100 in this non-limiting, exemplary illustration uses a lock mechanism 424 that does not use a spring but instead, uses a metallic member 426 in combination with a lock member 428a or 428b. Lock mechanism 424 is comprised of member 426 that is comprise of a metal that transfers the magnetic force from a well-known detacher (not shown) to lock member 428a/b to unlock the lock member 428a/b from serrated member 430. That is, lock mechanism 424 is comprised of a metallic member 426, lock member 428a/b, and a serrated member 430. The serrated member 430 is coupled with first side 402 of through section 244. In other words, in this non-limiting, exemplary embodiment, first side 402 accommodates a serrated member 430 rather than being serrated.

As further illustrated, lock mechanism 424 further includes lock member 428a or 428b. Preferred lock member 428a includes a base 442 that is secured within compartment 438 (of second member 206) by extending into slotted openings formed by a pair of tabs 440 as shown in FIG. 4K, whereby base 442 extends into housing 438, and a hook portion 444 of lock member 428 faces serrated member 430 (best illustrated in FIG. 4L). Hook 444 has a slight down angle forcing the end of hook 444 into serration member 430. This locks the tag, not allowing it to open but allowing retainer 210 to further move for a move tighter grip. To unlock (release) the tag a magnetic detacher is placed on the disc 456 of member 426. The magnetic force transfers through member 426, lifting hook 444 out of the teeth (serrations) of serrated member 430 and allowing the retainer 210 to release and the tag be removed from the article 102.

Lock member 428b (FIG. 4P) is comprised of metal tine 432. Tine 432 of lock member 428b preferably is lanced from a flat spring metal strip of material 434 so as to extend in an outwardly direction towards serrated member 430 when fully assembled. Tine 432 is integrally connected to strip 434 by hinge segment 436 in order to be easily moved to its unlock position along and as a part of strip 434. Metal strip 434 is secured within compartment 438 by extending into slotted opening formed by the pair of tabs 440 as shown in FIG. 4K, whereby hinge segment 436 extend into housing 438, with hook portion 446 of tine 432 facing serrated member 430. The free ends of tine 432 and strips 434 are accommodated within compartment 448 defined by slotted opening formed by a pair of tabs 450 as shown in FIG. 4H. Operation of lock member 428b is similar to that of lock member 428a wherein the tine 432 moves due to magnetic force applied by a detacher.

As indicated above, lock mechanism 424 includes metallic member 426 that transfers the magnetic force from a well-known detacher (not shown) to lock member 428a/b to move away and unlock lock member 428a/b from serrated member 430. Member 426 is housed within lock mechanism housing 216, and is comprised of a substantially cylindrical dumbbell configuration with cylindrical body 452 and first and second disc structures 454 and 456. The wider first disc structure 454 extends out of lock mechanism housing 216 (best illustrated in FIGS. 4G and 4H), with body 452 housed within and second, smaller disc structure 456 visible (shown in FIGS. 4D and 4E).

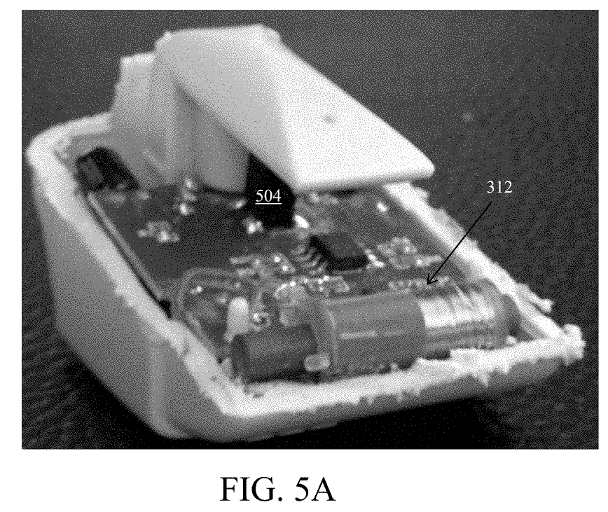

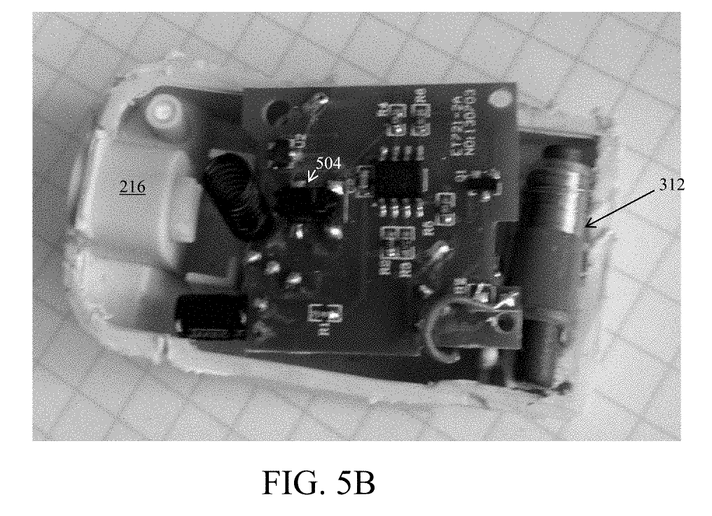

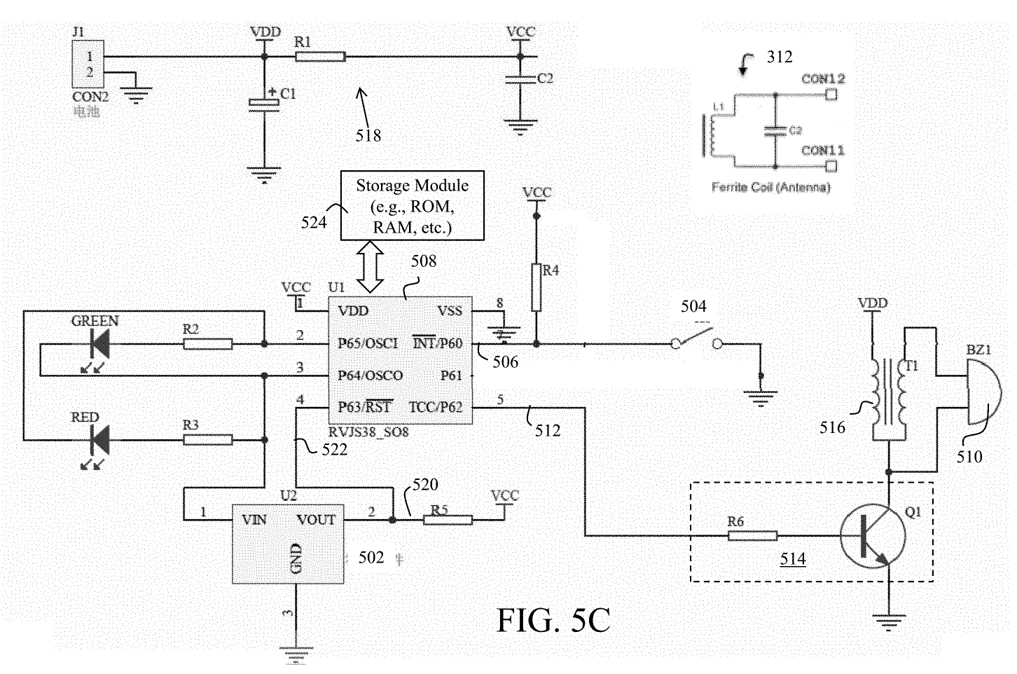

FIGS. 5A to 5C are non-limiting, exemplary illustrations of EAS alarm circuitry in accordance with one or more embodiments of the present invention. EAS alarm tag 100 includes a Printed Circuit Board (PCB) that accommodates a reset switch (e.g., a magnetic switch) 502 for resetting an alarm system of EAS alarm tag 100 to disarm, an alarm switch 504 (e.g., a plunger switch) to arm the alarm system. Further included is a triggering unit (e.g., tag circuit or marker 312) that senses and detects surveillance signals to generate a detected surveillance signal that triggers an external EAS alarm system, external EAS alarm tag 100.

Tag circuit or maker 312 that respond to specific types of electronic surveillance signals of different types of EAS systems, non-limiting examples of which may include Magnetic, Acousto-Magnetic (AM), Radio Frequency (RF), Microwave, etc. For example, tag circuit 312 may comprise a ferrite coil antenna that includes an inductor L and capacitor C (e.g., an LC tank) for radio frequency (RF) systems, amorphous metals for Magnetic systems, magnetostrictive and or ferromagnetic amorphous metals for use with acousto-magnetic (AM) systems, or non-linear elements such as a diode for Microwave systems. It should be noted that several tag circuits 312 of different types may be used within the same theft deterrent tag 100, with each tuned to a different resonant frequency and or systems for activation of different types of EAS systems. A non-limiting example of a resonant tag circuit (with passive LC tank) is detailed in U.S. Pat. No. 7,336,180 to Sayegh et al., the entire disclosure of which is incorporated by reference herein in its entirety.

When EAS alarm tag 100 is secured onto article 102 and alarm switch 504 is actuated the alarm system of EAS alarm tag 100 is armed, and when EAS alarm tag 100 is detached and removed from article 102 while EAS module 310 is still armed, an alarm system of EAS alarm tag 100 triggers an alarm. The actuator 208 closes alarm switch 504 to arm the alarm as described above.

As best illustrated in FIG. 5C, which is an exemplary schematic circuit illustration of an alarm system, EAS alarm tag 100 includes a reset switch 502 (a magnetic switch, e.g., a hall sensor, reed, or other magnetic type switch) for resetting an alarm system of the alarm tag to disarm, an alarm switch 504 (e.g., plunger switch) to arm the alarm, and a triggering unit (one or more markers 312) that senses surveillance signals to generate a detected surveillance signal that triggers an external alarm of an associated EAS system. Power is generally provided to the alarm system by a battery via a well-known power filter 518. The reset switch 502 illustrated in FIG. 5C represents a magnetic switch. When EAS alarm tag 100 is brought into contact with a magnetic detacher, the reset switch 502 is reset (or closed), which pulls line 520 to a low (“0”) to provide a logic “0” to MCU 508 via line 522, instructing MCU 508 to reset. This enables the alarm system to be reset, deactivating or disarming the entire alarm system.

As illustrated in FIG. 5C, EAS alarm tag 100 is armed when a plunger of alarm switch 504 is moved by actuator 208 to a closed position to close alarm switch 504. Closure of alarm switch 504 completes a circuit for arming the alarm system of EAS alarm tag 100. The closing of alarm switch 504 pulls to ground power voltage VCC at one end via a current limiting resistor R4. When alarm switch 504 is closed, the output of alarm switch 504 is pulled low and set to “0,” and inputted to a first input line 506 of one or more input lines of a microcontroller unit (MCU) 508 for arming EAS alarm tag 100. Once armed, the MCU 508 initially activates various indicators that show that EAS alarm tag 100 has armed, non-limiting examples of which may include flashing of a GREEN LED and a sounding of a transducer (e.g., a buzzer) 510 for a short time duration of a second or two. Thereafter the initial arming period, the GREEN LED is simply flashed at some desired predetermined interval to continue to indicate that EAS alarm tag 100 is armed. Accordingly, while article 102 is maintained within gap 106 of EAS alarm tag 100, pressing against actuator 208 which, in turn, continues to hold the plunger of alarm switch 504 in a closed position, EAS alarm tag 100 remains armed.

However, an unauthorized detachment and removal (e.g., by pulling tag 100 in the direction as shown by arrow 104) to detach and remove it from article 102 without tag 100 being neutralized for proper disengagement would trigger an alarm without the pull damaging article 102. That is, when EAS alarm tag 100 is removed from article 102, the actuator 208 is freely moved into gap 106 as there is nothing blocking its free motion. The actuator 208 is moved into gap 106 by a biasing spring of the plunger of alarm switch 504, which itself is now free to move to its default open position as no article 102 presses against actuator 208 which, in turn would be pressing the plunger to closed position. When alarm switch 504 opens while EAS alarm tag 100 is armed, MCU 508 triggers the alarm by activating audio/visual indicators, non-limiting examples of which may include flashing of RED LED and activation of transducer (e.g., buzzer) 510.

The transducer unit 510 is actuated by a pulsed output signal that is output from MCU 508 via line 512, and amplified by an output amplifier 514. The output amplifier 514 is comprised of a BJT transistor Q1 with an emitter coupled to ground, a collector coupled to a transformer 516 of the transducer 510, and a base that is coupled with a current limiting resistor R6.

Transistor Q1 amplifies the pulsed output signal from line 512 to alternately drive transformer 516 from high VDD to ground and vice versa, with the transformed pulsed signal driving the ceramic transducer 510 to generate an audible alarm. It should be noted that well-known software routine within MCU 508 may generate this pulsed output at a certain frequency, which is amplified by transistor Q1.

MCU 508 is a well-known process (by ELAN MICROELECTRONICS™ model EM78P153B) mounted onto the PCB with an internal memory 524 (e.g., an EEPROM, ROM, and or a RAM) that includes a set of instructions. MCU 508 receives one or more input signals from one or more input periphery devices and generates one or more processed output signals for actuation of one or more periphery output devices. The processing of data may include Analog to Digital (A/D) or D/A conversion of signals, and further, each input or pin of MCU 508 may be coupled with various multiplexers to enable processing of several multiple input signals from different input periphery devices with similar processing requirements. Non-limiting examples of one or more input periphery devices may exemplarily include reset switch 502, alarm switch 504, and non-limiting examples of one or more output periphery devices may exemplarily include the use of vibration mechanisms, audio, visual or any other indicators to alarm and notify a user regarding an occurrence. Power and ground connections to the MCU 508 are set forth in accordance with manufacturer specification.

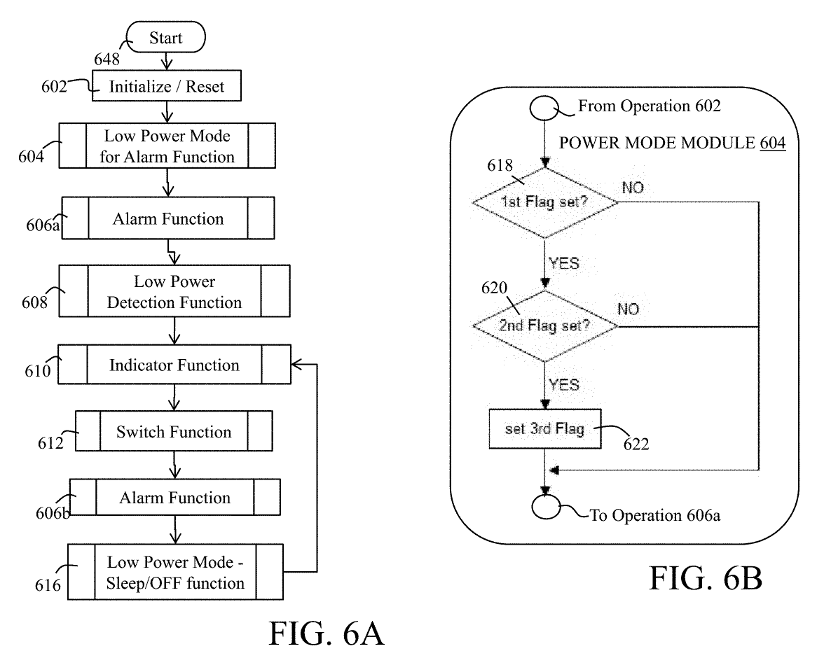

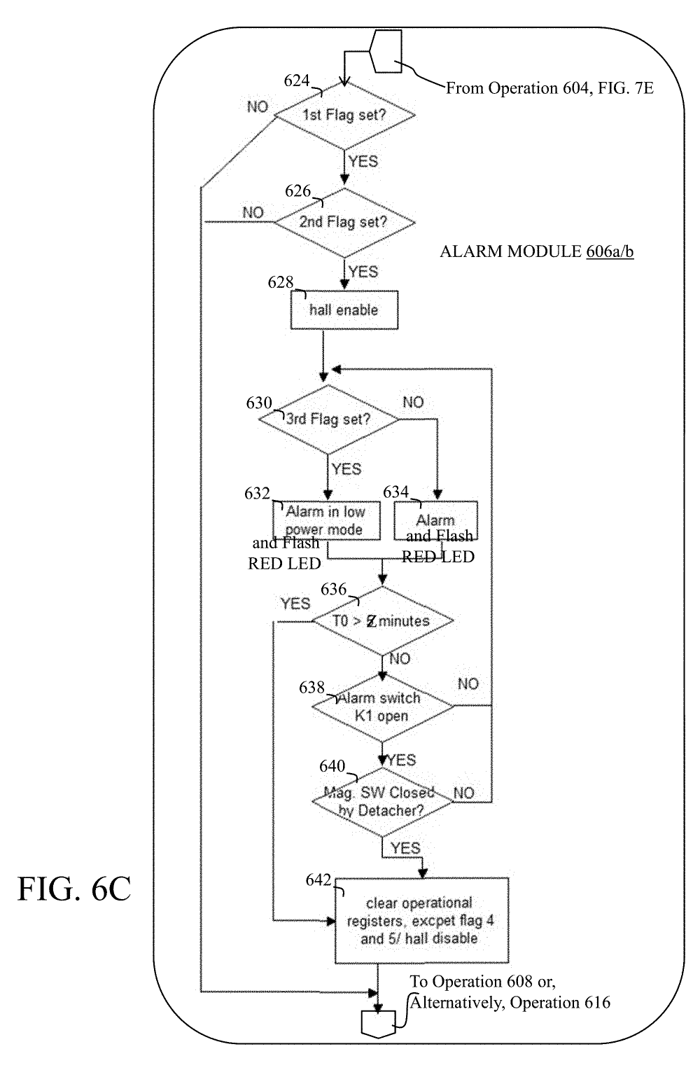

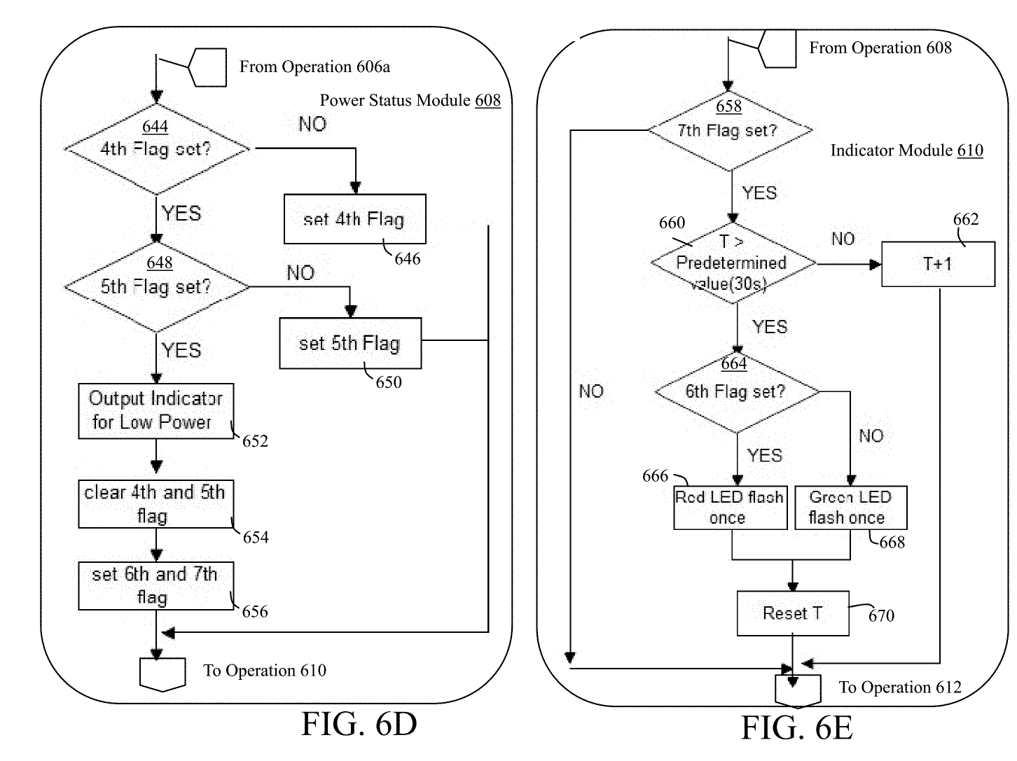

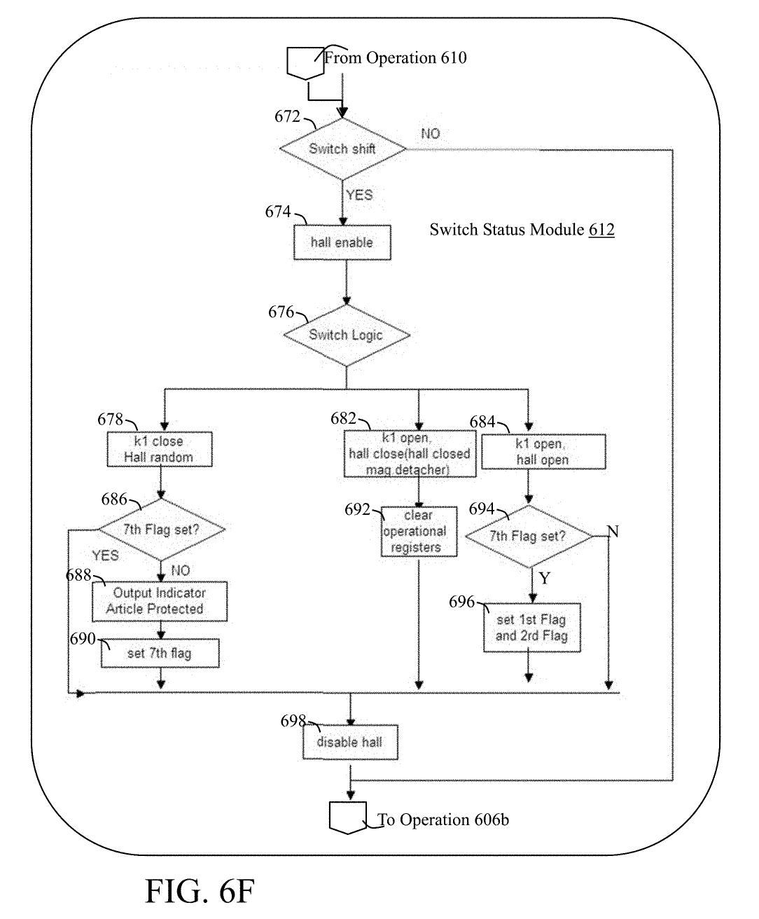

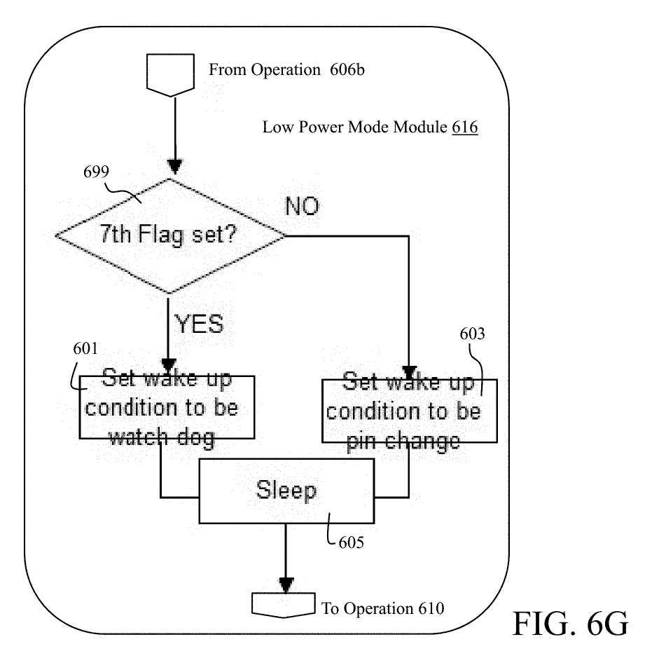

FIGS. 6A to 6G are non-limiting, exemplary illustration of a flowchart, which amongst other aspects, also illustrate the power management and functionality of MCU 508 for EAS alarm tag 100. As illustrated in FIG. 6A, upon installing a power source such as a battery within EAS alarm tag 100 at operation 648, during normal operation when normal level of power is available, MCU 508 is turned ON and initialized to default settings at operation 602. However, MCU 508 may also be reset at operation 602 if the voltage level supplied to MCU 508 from battery falls below a predetermined voltage level.

At operation 604, MCU 508 determines the operating power mode for the next subsequent operation, which is the alarm function operations 606a (also 606b as detailed below). That is, power mode operations 604 enable MCU 508 to determine whether to continue executing alarm function operations 606a/606b with a triggered alarm at normal power mode or low power mode. In other words, if MCU 508 has been reset at operation 602 due to low power caused by extended triggered alarm, MCU 508 would execute alarm function operation 606a/606b with continued triggered alarm in a low power mode once MCU 508 has reset at operation 602.

As further illustrated in FIG. 6A, alarm function operations 606a/606b are comprised of alarm functionality of EAS alarm tag 100 processed by MCU 508, which trigger an alarm of EAS alarm tag 100 in different power modes including normal or low power mode alarms.

As further detailed below, low power detection function operations 608 illustrated in FIG. 6A enables MCU 508 to determine the power status of the battery. Indicator function operations 610 operate visual indicators such as LED lights, with switch function operations 612 determining the status of switches and their conditions (e.g., closed, open, random (or undetermined)), various combinations of which may trigger an alarm, place the EAS alarm tag 100 in sleep mode, etc. Low power mode sleep/OFF function operations 616 enable EAS alarm tag 100 to switch to low power sleep/OFF mode and also setup and determine the type of wakeup operations (e.g., watchdog, pin condition, etc.) to be used to wake EAS alarm tag 100 from low power sleep/OFF mode. That is, prior to operation 605 that would place EAS alarm tag 100 into sleep/OFF mode, one of the operations 601 or 603 are processed to set the wakeup condition or criteria (i.e., based on Watchdog timer or pin conditions) that would allow EAS alarm tag 100 to wake up.

FIG. 6B details power mode operations 604 and as illustrated, operations 618, 620, and 622 are used to determine if alarm function operations 606a/606b are to operate the alarm at normal power mode or low power mode. This scheme extends the life of the battery while maintaining continued operation of the alarm, but in low power mode to continue to protect an article. That is, the scheme enables continued triggering of an alarm when executing alarm function operation 606a/606b in low power mode of operation, which use less battery power.

In this non-limiting, exemplary instance, present invention implements power mode operations 604 using various flags, settings of which indicate to MCU 508 that it has been reset due to low battery power caused by an extended triggered alarm. It is through checking settings of the first and second flags at respective operations 618 and 620 that MCU 508 determines the type of power mode to be used for alarm function operations 606a/606b. For example, if first and second flags are determined as set (operations 618 and 620), MCU 508 sets a third flag and the process flows to the next operation, which is alarm function operations 606a/606b. As best illustrated in FIG. 6C, with the first, the second, and the third flags determined to have been set (at respective operations 624, 626, and 630), MCU 508 processes operation 632, which is alarming in low power mode.

Referring back to FIGS. 6A and 6B, accordingly and as further detailed below, while EAS alarm tag 100 continues to alarm at alarm function operations 606a/606b, MCU 508 continuously monitors minimum battery power level required to continue alarm operation in a normal power mode at operation 634 shown FIG. 6C. If power level drops below that which is required for normal operation (e.g., due to extended alarm condition at operation 634 of alarm function operations 606a/606b), MCU 508 resets.

MCU 508 is preprogrammed (by manufacturer) with a built-in Power On Reset (POR) feature that when voltage level drops below a certain minimum threshold, it resets. That is, MCU 508 is programmed to switch OFF and then reset to ON when power supplied to MCU 508 falls below a predetermined level. Accordingly and as detailed below, one or more embodiments of the present invention provide various mechanisms that use the POR feature of MCU 508 to extend battery life by determining if the MCU 508 had been reset at operation 602 due to low power only (operations 608), low power caused by extended triggered alarm (operations 604), or others. Therefore, one or more embodiments of the present invention use the manufacturer's preprogrammed POR feature of the MCU 508 to prolong battery life and hence, overall operation of EAS alarm tag 100.

As part of initialization and or reset at operation 602 due to a low power level caused by extended alarm condition, when MCU 508 is reset, it is instructed to read a memory to determine if a first and a second flags were set (at operation 696, FIG. 6F) prior to reset. In general, as indicated above, when EAS alarm tag 100 alarms at alarm function operations 606a/606b for an extended duration and power falls below a predetermined level due to an extended triggered alarm, the low level of power may cause the MCU 508 to reset, which would eventually transfer flow from alarm function operations 606a/606b to operation 602. However, before resetting, MCU 508 is instructed in accordance with the present invention to first set the first and second flags at operation 696 at memory location 524 due to certain switch conditions (at switch function operations 612). Therefore, when MCU 508 is reset (switched OFF) and turned back ON, MCU 508 would recognize (at operation 604) that it had triggered alarm before it reset by checking the first and second flags at respective operations 618 and 620. According, when MCU 508 is reset and ON again, MCU 508 reads the memory 524 for first and second flags to determine if it was alarming before MCU 508 was reset. In other words, MCU 508 at power mode operation 604 determines if it has been reset due to lower power supply (set by manufacturer) and further, if there was an alarm condition prior to reset by checking for set first and second flags in memory 524. If EAS alarm tag 100 has been reset due to lower power and the first and the second flags were set (due by an alarm condition), MCU 508 would operate an alarm at a low power mode at alarm function operations 606a/606b as soon as it is reset.

It should be noted that when MCU 508 is reset at operation 602 (as a result of low power reset), it shuts-off for a short duration and once reset to ON, the MCU 508 reconfigures the frequency of operating transducer 510 to a lower decibel and hence, processing operation 632 based on the first, second, and third flags is executed, with alarm triggered at operation 632 at a lower decibel.

It should be further noted that setting first and second flags in memory 524 so that a reset MCU 508 would recognize an alarm condition when it is reset is one of many methods for MCU 508 to determine if itself has been reset due to low power caused by triggered alarm at operation 604. Nonetheless, combination of operations 602 and 604 ensure an increased duration and usage for battery life. That is, during normal operation a first minimum voltage (for example, 2 V) is used and required to trigger an alarm at normal levels (for example, the transducer or buzzer 510 is actuated at about 95 db). When power falls below a minimum voltage (for example, 1.8 V), the combined operations 606, 604, and 606a/606b allow EAS alarm tag 100 to continue alarm at operation 632 below the minimum voltage at a low power mode alarm, for example, actuating the buzzer 510 at a lower decibel level (e.g., at about 80 db), which would require and use less power and thus extending the life of the battery.

Referring back to FIG. 5C, MCU 508 triggers alarm (the buzzer 510) at low power mode operation 606 at a lower decibel by changing output signal characteristics such as a frequency of signal output on line 512. It should be noted that MCU 508 determines the minimum voltage for a reset by determining the voltage differences between voltage VCC supplied to MCU 508 and voltage VDD supplied to the buzzer 510. In general, as shown in power filter 518, voltage VCC and voltage VDD are substantially equal with the exception of a small voltage drop across resistor R1 that has low impedance. When the buzzer 510 is active at operation 634, the voltage VDD is pulled to ground to activate the buzzer 510 and if active for an extended period, the reduced voltage of VDD is reflected in voltage VCC that is supplied to MCU 508 where the reduced level is detected to reset MCU 508. In other words, the power level is monitored by MCU 508 based on the voltage VCC, which fluctuates commensurate with variations in voltage VDD supplied to buzzer 510 at operation 634. It should be noted that all data for all of the flags may be set and reset within memory 524 by MCU 508.

Referring back to FIG. 6A and assuming normal operations with no triggered alarm, only operation 618 of low power mode for alarm function operations 604 is processed (FIG. 6B), and next, only operation 624 (FIG. 6C) of alarm function operations 606a is processed (at least at this point of the description of the flow). Thereafter, low power detection function operations 608 (FIG. 6D) are processed to determine if EAS alarm tag 100 should output a low power indicator.

As show in FIG. 6D, in this non-limiting, exemplary instance, the present invention implements low power mode detection function for determining the status of the battery power using various flags, settings of which indicate to the MCU 508 the status of the battery as detailed below. It is through checking settings of the fourth and fifth flags at respective operations 644 and 648 that MCU 508 determines the status of the battery. For example, if fourth and fifth flags are determined as set (operations 644 and 648), MCU 508 outputs indicator (e.g., audio/visual/mechanical such as vibration as indicators) to inform users of a low power battery at operation 652. It should be noted that operation 652 is actually executed by operation 666 of indicator module 610. It is for compactness of disclosure and better understanding of operational flows that operation 652 is exemplarily illustrated in FIG. 6D. Accordingly, operation 652 may simply be deleted, where after operation 648, operation 654 and so on is executed. Next, at operation 654 MCU 508 clears the fourth and fifth flags, sets sixth and seventh flags at operation 656 (detailed below), and the process flows to the next operation, which is the indicator function operations 610. The use for clearing/setting flags at operations 654 and 656 is detailed below.

Assuming a scenario that MCU 508 continues operations with no alarm condition for an extended period to a point where the power level of the battery falls below the minimum for normal operations, MCU 508 will reset as described above and process will transfer to operation 602. After reset, at operation 604, MCU 508 determines if it had been reset due to lower power caused by triggered alarm and in this scenario, it was not because the scenario assumed was a low battery power with no alarm and hence, the next operation 606a is processed.

Continuing with the same assumed scenario of the preceding paragraph and referring to FIG. 6D, during normal operations the fourth flag was set at operations 644 and 646 and hence, during low power mode operations after being reset, MCU 508 determines if fourth flag is set at operation 644 and if set, MCU 508 determines if a fifth flag is set at operation 648 and if no fifth flag is set, MCU 508 at operation 650 sets the fifth flag and continues with operation 658 of indicator function operations 610 (FIG. 6E).

Assuming that EAS alarm tag 100 continues operation and is reset again, upon reaching low power detection function 608, MCU 508 determines that fourth and fifth flags were already set (operations 644 and 648). Next, operation 652 is processed where MCU 508 outputs an indication of low battery power mode to end-user (via operation 666). The EAS alarm tag 100 may be reset again for a variety of reasons during its use. For example, the EAS alarm tag 100 may be armed and connected to an article for protection and reset in a normal manner by an authorized users where operation 642 (FIG. 6C) is processed, enabling the process to flow to operation 602, and eventually reach back to low power detection function operations 608 where operation 652 is processed. The use of fourth to seventh flags is further provided in detail below however, in the first iteration or run of the program, MCU 508 determines if a fourth flag has been set at operation 644, and sets the fourth flag at operation 646 and the process flows to indicator function operations 610, regardless.

Referring back to FIG. 6A and continuing with the assumption of normal operations with no triggered alarm, process moves from operation 646 of the low power mode detection function operations 608 to operation 658 of indicator function operations 610 (detailed in FIG. 6E). As show in FIG. 6E, in this non-limiting, exemplary instance, an embodiment of the present invention implements indicator function operations for activating indicators based on various operations and use of the tag, which as with other functions, are also implemented using various flags. Accordingly, it is through checking settings of the seventh and sixth flags at respective operations 658 and 664 that MCU 508 determines which operation (666 or 668) to process to activate the desired indicator, if any. For example, if seventh flag is not set, no operation is performed to output an indicator and if seventh and sixth flags are determined as set (at respective operations 658 and 664), MCU 508 outputs indicator, which may occur when the tag is first initialized. Indicator function operations 610 also include a “timer” scheme that enables the indicators to remain active for a certain period, with the time reset thereafter. In the scenario indicated in this paragraph, MCU 508 would determine at operation 658 that the seventh flag is not set (at least not at this point of the flow being described) and therefore, the process flows to the next operation, which is switch function operations 612.

Referring back to FIG. 6A and continuing with the assumption of normal operations with no triggered alarm, process moves from operation 658 or 670 of the indicator function operations 610 to operation 672 of the switch function operations 612 (detailed in FIG. 6F). As show in FIG. 6F, in this non-limiting, exemplary instance, the present invention implements switch function operations 612 based on various operations and use of EAS alarm tag 100, including switching activities and statuses. In the scenario indicated in this paragraph (and at least at this point of the flow being described), MCU 508 would determine at operation 672 that no switch has a changed or modified status or condition as the default settings during initialization operation 602 for the switches is an open switch condition. Accordingly, operation 672 enables determination of whether a switch (any switch being tracked by the flow—e.g., alarm switch 504, etc.) has a changed or modified status or condition compared to previous determination when operation 672 was processed. Therefore, when a switch is opened or closed (i.e., has changed its status), that change is recorded and tracked and used in operation 672. For example, the status or condition of alarm switch 504 would be considered as having no change if it has remained and continues to remain open or closed since the previous processing of operation 672 and therefore, the process flows to the next operation, which is alarm function operations 606b.

Referring back to FIG. 6A and assuming normal operations with no triggered alarm at this point of the flow being described, only operation 624 of the alarm function operations 606b is processed. Thereafter, low power mode (Sleep/OFF) function operations 616 are processed, which is detailed in FIG. 6G. As show in FIG. 6G, in this non-limiting, exemplary instance, the present invention implements low power mode (Sleep) functions operations 616 to place EAS alarm tag 100 into sleep mode. Additionally, low power mode (Sleep) functions operations 616 also provide multiple methods to enable EAS alarm tag 100 to exit from sleep or low power mode to normal mode of operation.

As illustrated in FIG. 6G, prior to processing sleep operation 605 and placing EAS alarm tag 100 into low power mode operations (sleep operations), one or more embodiments of the present invention set the type of wake up condition to be used after the MCU 508 enters sleep operation 605. In the scenario indicated in this paragraph and at this point of the flow being described, MCU 508 would determine at operation 699 that the seventh flag has not been set and therefore, MCU 508 would switch out of sleep operation 605 due to pin change. It should be noted that the MCU 508 will remain at operation 605 unit one of the wake up conditions (operation 601 or 603) are met. Accordingly, MCU 508 flow process will remain at operation 605 and will not move to the next operation, which is indicator function operations 610 until MCU 508 is waken up in accordance with one of set wake up conditions operations (601 or 603).

MCU 508 at operation 603 sets a wake up condition based on a change in status or condition detected at any of the used Input/Output (I/O) ports of MCU 508. For example, opening or closing alarm switch 504 would cause a change in the voltage value at the input port pin “P60” of MCU 508 as described above in relation to FIG. 5C, which can be hardware detected by the MCU 508 and enable the processor to exit Sleep/OFF mode from operation 605. Accordingly, at operation 603, MCU 508 sets up the wake up condition to be based on a change in the status detected by the MCU 508 hardware at any of the used I/O ports of the MCU 508. It should be noted that the detection is hardware based. Once set, MCU 508 at operation 605 remains at Sleep/OFF mode until the hardware change at one of the I/O ports has been detected. Of course, once a change is detected at the I/O port, process flow transfers to indicator function operations 610. As to operation 601, MCU 508 at operation 601 sets a wake up condition based on a Watchdog Timer, which is very well known. In other words, the Watchdog Timer enables MCU 508 to exit out of operation 605 based on some predetermined timing scheme, with the process flow transferring to indicator function operations 610.

Referring back to FIG. 6A and continuing with the assumption of normal operations with no triggered alarm, process transfers to operation 658 of indicator function operations 610 (FIG. 6E), where MCU 508 determines that the seventh flag has not been set (at this point of the description of the flow) and therefore, the process flows to the next operation, which is the switch function operations 612 (FIG. 6F). Assuming now that MCU 508 had exited the Sleep operation 605 due to change in the status of an input port (for example, a switch had closed or opened, which would change the voltage value at an input pin of MCU 508, enabling the MCU 508 to exit sleep mode). The change in condition or status of the switch is also tracked and registered for switch function operations 612. Accordingly, at operation 672 of the switch function operations 612, MCU 508 determines that a switch (any switch) has a changed or modified status or condition compared to previous determination when operation 672 was processed. As indicated above, as a default, switches may be set to open at first during initialization operation 602. Accordingly, since change in switching status or condition of at least one switch is detected at operation 672, next operation 674 is processed where MCU 508 powers ON to activate reset switch 502. Accordingly and as best illustrated in FIG. 5C, reset switch 502 is OFF and is powered ON by the MCU 508 at the input Vin of the reset switch 502, which places a high voltage (or a “1”) into input pin P63 of the MCU 508. A magnetic detacher may be used to change the value at pin P63, where the indicated VCC is driven to GND. (It should be noted that reset switch 502 is powered OFF to save power.) Thereafter, MCU 508 processes case switch logic operations 676 with different cases (or scenario) operations, which are indicated as case operations 678, 682, and 684.

Case operation 678 is for the case where alarm switch 504 is closed, but the condition of the reset switch 502 is not relevant (it may be ON or OFF). Case operation 682 is for the case where alarm switch 504 is open and the reset switch 502 is closed (e.g., by a magnetic detacher). For the case operation 682, all operational registers (or flags) are cleared at operation 692. Case operation 684 is for the case where alarm switch 504 is open and the reset switch 502 is open. Accordingly, operations 678, 682, and 684 are different cases for various combinations and permutations of switching activities, with each having different consequences.

Continuing with the assumption of normal operations with no triggered alarm and with alarm switch 504 closed (which would cause EAS alarm tag 100 to exit sleep mode operations 605), then case operation 678 for the case where alarm switch 504 is closed and the status of the reset switch 502 is irrelevant is processed. For the case operation 678, operation 686 is processed where MCU 508 determines if a seventh flag has been set and if no, MCU 508 at operation 688 outputs indicators (via indicator function operations 610) that article is protected and sets the seventh flag at operation 690. At this point and under the assuming scenario, only the fourth and seventh flags have been set so far. At operation 698 MCU 508 powers down the reset switch 502 (if ON) and operation is transferred to alarm function operations 606b, where only operation 624 is processed and the remaining processes flow to low power mode (sleep/OFF) function operations 616. Since flag seven was set at switch function operations 612, at operation 699 of the low power mode (sleep/OFF) function operations 616 (FIG. 6G), the MCU 508 determines that the seventh flag is set and therefore, sets wake up condition to be Watchdog Timer at operation 601, and at operation 605 EAS alarm tag 100 enters sleep mode. The Watchdog Timer enables MCU 508 to exit out of operation 605 based on some predetermined timing scheme, with the process flow transferring to indicator function operations 610 (FIG. 6E) to output indicators that the article is protected (as required by operation 688 of switch function operations 612).

Assuming that the EAS alarm tag 100 exists sleep mode operation 605, at indicator function operation 610 (FIG. 6E), MCU 508 determines at operation 658 that the seventh flag is set and therefore, at operation 660 determines if a time T (default being at zero) is greater than a predetermined time and if not, the process flow is transferred to the next operation, which is the switch function operations 610. Since there are no changes in switch status (alarm switch 504 is still closed in accordance with the above scenario), the process moves to the next operation, which is the alarm function operation 606b, where only operation 624 is processed at this point of the flow description. Thereafter, the process flow is transferred to low power mode (sleep/OFF) function operations 616 where MCU 508 again enters sleep operation 605 only to exit from there as a result of the timing scheme of the Watchdog Timer (in general, the time period of the Watchdog timer is much shorter than time T at operation 660). Thereafter, once the Watchdog timer period is expired, the process flows back to indicator function operations 610. The entire loop is repeated for several iterations until MCU 508 determines that the time T has elapsed to a value that is greater than the predetermined value at operation 660 of the indicator function operations 610. Thereafter, MCU 508 determines if a sixth flag has been set at operation 664 and if no, a GREEN LED flashes once at operation 668 and the time T is reset to a default value. This entire process continues to repeat while EAS alarm tag 100 is armed (due to closure of alarm switch 504), with GREEN LED flashing, which indicates that the article is protected. The above may be interrupted if the switch function operations 612 detect a change of status or conditions in any one of the switches or, if the power of the battery drops below a threshold level where MCU 508 resets (where process flow is transferred to operation 602).

Assume now that an unauthorized individual removes EAS alarm tag 100 from an article. That is, EAS alarm tag 100 armed as indicated above, an unauthorized user abruptly pulls or removes EAS alarm tag 100 from an article, which causes alarm switch 504 to open. In this case switch function operations 612 detects a change of status or condition in alarm switch 504. Accordingly, after processing indicator function operations 610 as indicated in the above-described loop, switch function operations 612 are processed. In this case, MCU 508 determines at operation 672 that a switch has a changed or modified status or condition (compared with previous iteration of the same operation, where alarm switch 504 was still closed). Accordingly, since change in switching status or condition of at least one switch (herein alarm switch 504) is detected at operation 672, next operation 674 is processed where MCU 508 powers ON to activate reset switch 502. Thereafter, MCU 508 processes case switch logic operations 676 with different cases (or scenario) operations, which are indicated as case operations 678, 682, and 684. In this non-limiting, exemplary instance, the case operation 684 is selected, which is for the case where alarm switch 504 is open and the reset switch 502 is open. That is alarm switch 504 has opened and no authorized individual has neutralized the tag with a magnetic detacher by resetting (closing) the reset switch 502. For the case operation 684, operation 694 is processed where MCU 508 determines if a seventh flag has been set. In this instance (where alarm switch 504 was closed), the seventh flag was set at operation 690 and therefore, MCU 508 determines that the seventh flag is set and continues with next operation where first and second flags are set at operation 696. At operation 698 MCU 508 powers down the reset switch 502 (if ON) and operation is transferred to alarm function operations 606b (FIG. 6C).

At alarm function operation 606b, MCU 508 determines at operations 624 and 626 that first and second flags are set and powers ON and activates reset switch 502 at operation 628. At operation 630, MCU 508 determines if a third flag has been set and if no, alarm operation 634 is processed. It should be noted that as indicated above, the third flag is set at low power mode for alarm function operations 606a/b when MCU 508 is reset due to low battery power caused by an extended alarm.

Continuing with alarm function operations 606b, at operation 636, MCU 508 determines if a predetermined time T0 has elapsed and if no, at operation 638 MCU 508 determines if alarm switch 504 is open. Assuming for now that at operation 638 alarm switch 504 is still open and that MCU 508 determines that alarm switch 504 is open, at operation 640 MCU 508 determines if reset switch 502 has been closed using a detacher. That is, an authorized person may have neutralized EAS alarm tag 100 using a detacher magnet. If MCU 508 determines that reset switch 502 is closed by a detacher, at operation 642 the flags are cleared with the exception of fourth and fifth flags and further, reset switch 502 is powered down. If at operation 640 MCU 508 determines that reset switch 502 is open, process is moved to operation 630, where the loop 630, 634, 636, 638, and 640 is repeated until TO has elapsed at which point, operation 642 is executed. Stated simply, once operation 634/632 triggers an alarm, EAS alarm tag 100 will continue to alarm for a specified duration of time T0 period or until interrupted by detacher.

In the above non-limiting, exemplary instance, operation is transferred from alarm function operations 606b (FIG. 6C) to low power mode sleep/OFF function operations 616, where MCU 508 determines if a seventh flag is set at operation 699. To continue with the scenario of the above paragraph, at operation 642 seventh flag was cleared and hence, MCU 508 determines that the seventh flag is not set at operation 699 and at operation 603 MCU 508 sets a wake up condition based on a change in status or condition detected at any of the used I/O ports of MCU 508. At operation 605 EAS alarm tag 100 is placed into sleep mode unit a change in status or condition of an I/O port is detected.

Assume now that due to several extended alarm conditions as described above, the battery power is now below the threshold level set by manufacturer of MCU 508. When an authorized individual reuses EAS alarm tag 100 to protect an article (by closing switch 504), MCU 508 exits Sleep operation 605 but this time, resets. Accordingly, processing is transferred to reset operation 602. It should be noted that at this time and continuing with the above scenarios, at operation 642 flags were cleared with the exception of fourth and fifth flags.

Assuming a reset with no triggered alarm, at low power mode for alarm function operations 604, only operation 618 is processed at this point of flow description where MCU 508 determines that first flag is not set. It should be noted that the reset in this assumption was not caused by low battery power due to extended alarm, but low battery power due to simple extended use of EAS alarm tag 100 and therefore, first flag was not set because there was no alarm. At alarm function operation 606a, only operation 624 is executed, as there is no alarm. Next, at low power detection function operation 608 MCU 508 determines at operations 644 and 648 fourth and fifth flags are set and therefore, outputs indicator for low power at operation 652, clears fourth and fifth flag at operation 654 and sets sixth and seventh flag at operation 656. At indicator function operations 610 (FIG. 6E), MCU 508 determines that both the seventh and sixth flags are set at operation 658 and 664, flashing a RED LED once, which is indicative of low battery power. It should be noted that the process to move from operation 658 to 664 via operation 660 is described above. That is, at operation 660 a timer T is set to zero default value and hence, it would take several iterations (the cumulative durations of which must become greater than a predetermined value T) before operation 644 is processed. For example, at first iteration (or run), at operation 660 a timer is incremented at operation 662 and the process is transferred to switch function operations 612 before the RED LED is activated at operation 666.

At switch function operations 612, MCU 508 determines at operation 672 that a switch has a changed or modified status or condition (compared with previous iteration of the same operation, where alarm switch 504 was open). Accordingly, since change in switching status or condition of at least one switch (herein alarm switch 504) is detected at operation 672, next operation 674 is processed where MCU 508 powers ON reset switch 502. Thereafter, MCU 508 processes case switch logic operations 678 for the case where alarm switch 504 is closed, but the condition of the reset switch 502 is not relevant (it may be ON or OFF).

For the case operation 678, operation 686 is processed where MCU 508 determines if a seventh flag has been set (at operation 656) and at operation 698 MCU 508 powers down the reset switch 502 (if ON) and operation is transferred to alarm function operations 606b, where only operation 624 is processed and the remaining processes flow to low power mode (sleep/OFF) function operations 616 (at least at this point of flow description). Since flag seven was set at switch function operations 656, at operation 699 of the low power mode (sleep/OFF) function operations 616, MCU 508 determines that the seventh flag is set and therefore, sets wake up condition to be Watchdog Timer at operation 601, and at operation 605 EAS alarm tag 100 enters sleep mode. Thereafter, at some predetermined timing scheme of the Watchdog time, the process flow transfers to indicator function operations 610 (FIG. 6E). The flow is repeated until time T becomes greater than a predetermined level where RED LED light is flashed at operation 666, and at operation 670 the timer T is reset where the processes is looped.

Assume now that EAS alarm tag 100 has a triggered alarm and that the battery power has reached below the threshold level where MCU 508 resets with a triggered alarm. In other words, EAS alarm tag 100 is armed with a triggered alarm condition (at operation 634) and is now reset due to low battery power at operation 602. Accordingly, at low power mode for alarm function operations 604, MCU 508 determines at operations 618 and 620 that the first and second flags were set (at operation 696) and at operation 622 MCU 508 sets a third flag. At alarm function operation 606a, MCU 508 processes operations 624, 626 and activates reset switch 502 and triggers alarm at low power mode operation 632. The remaining operations are described above.

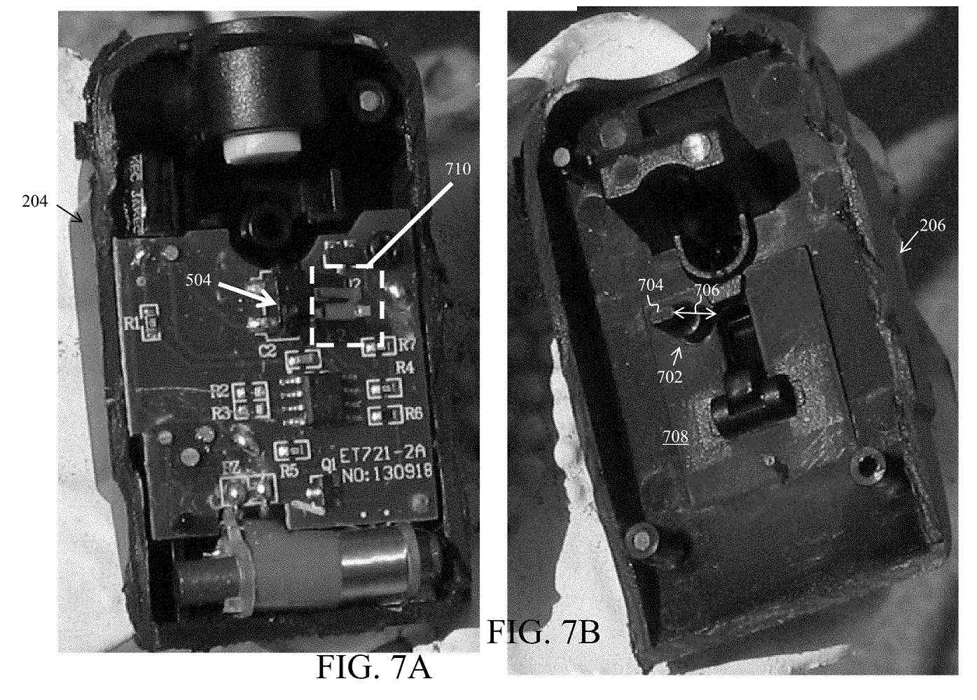

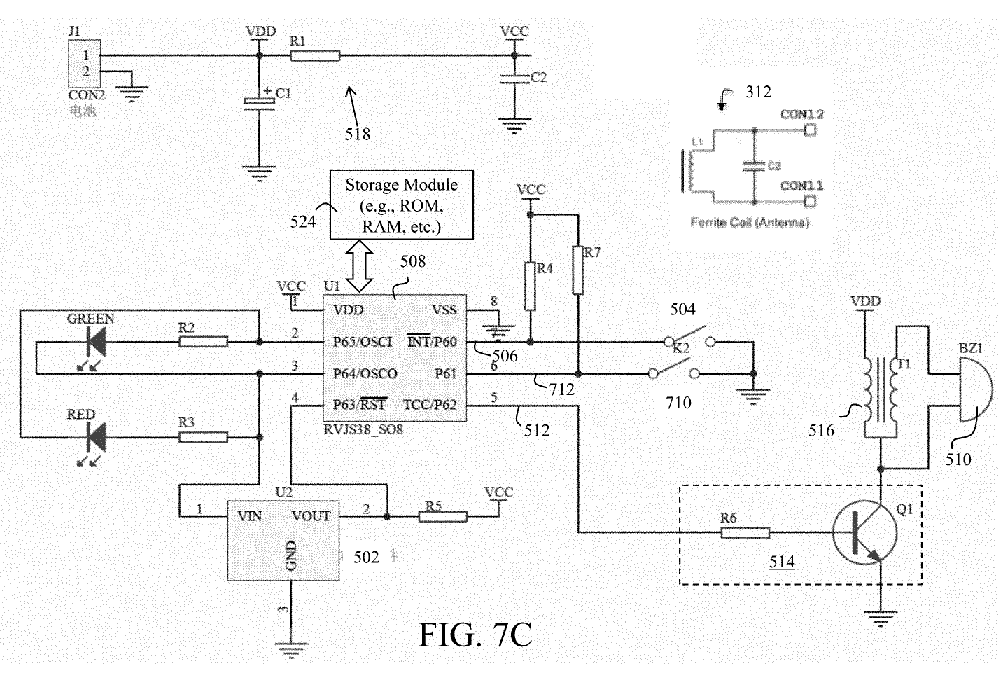

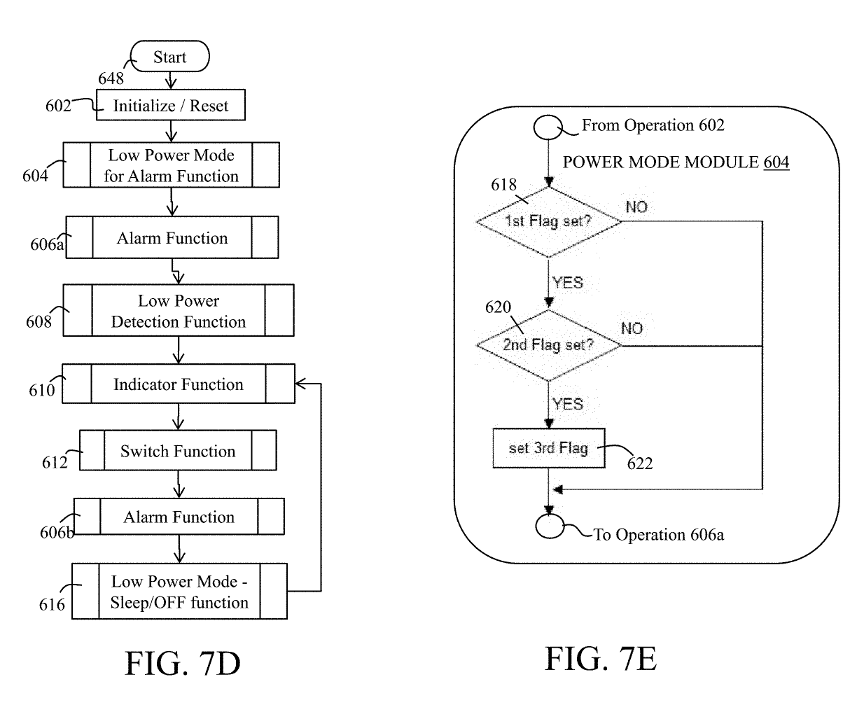

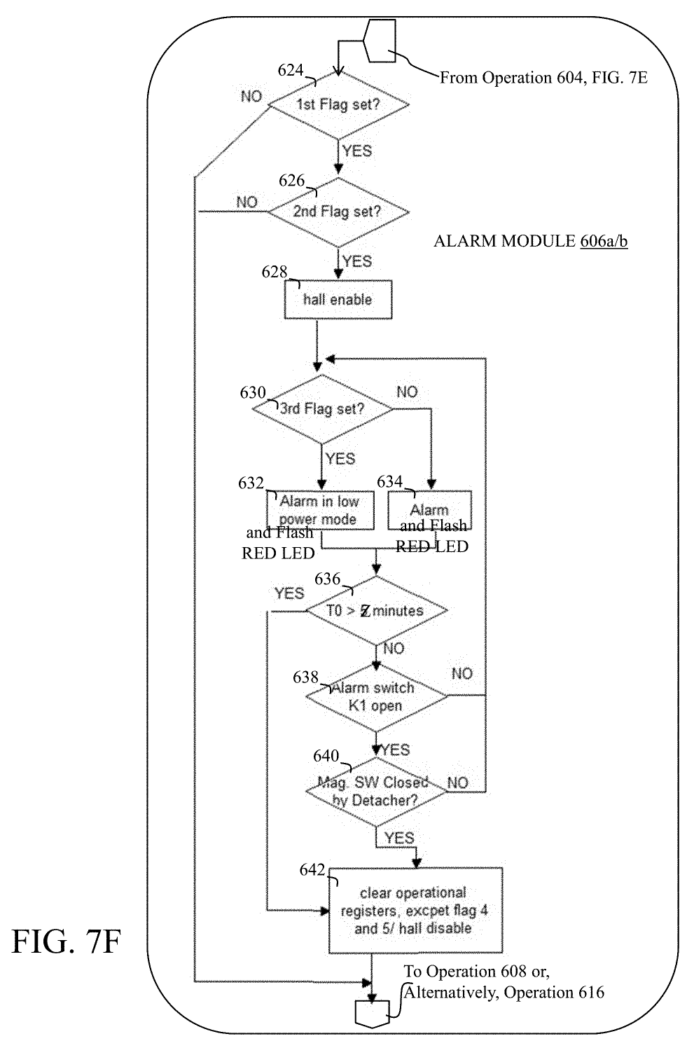

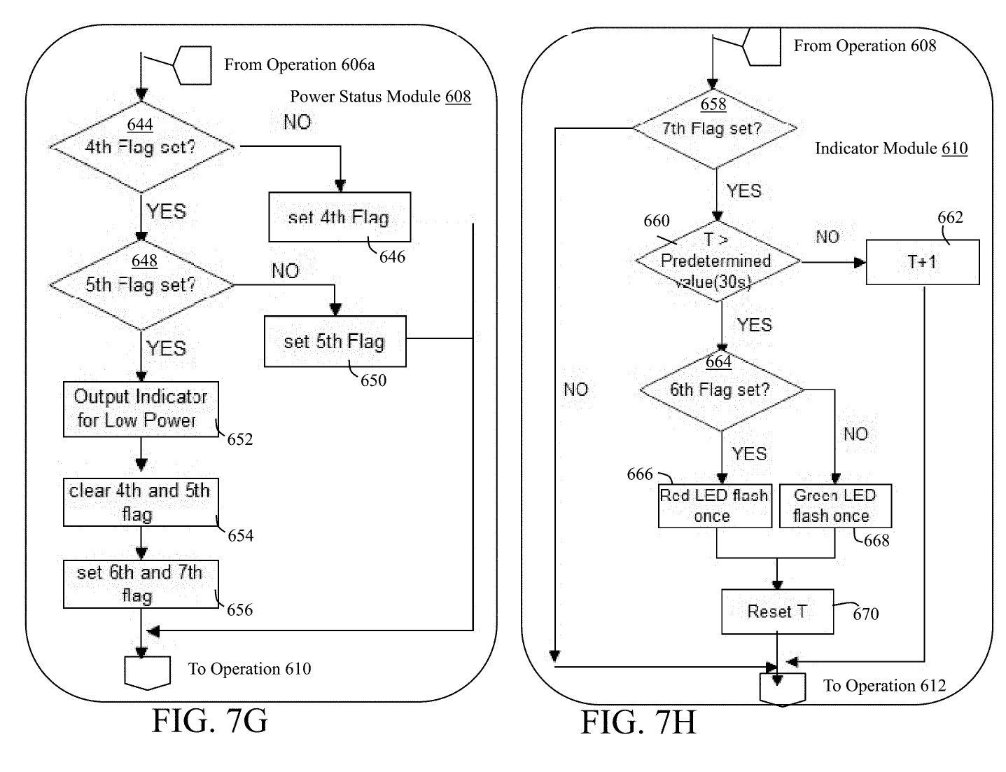

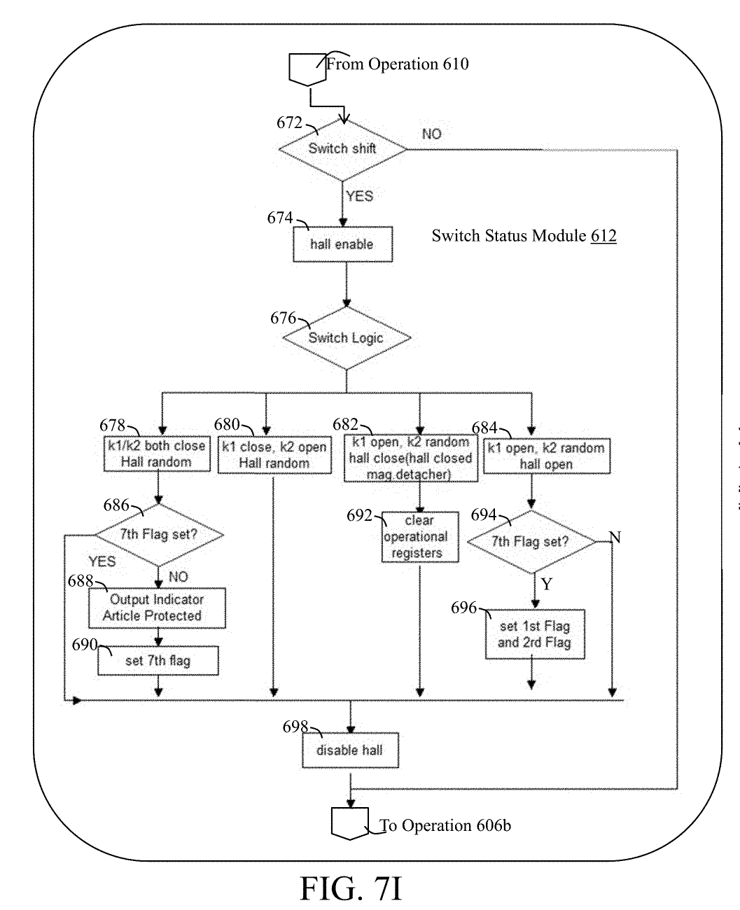

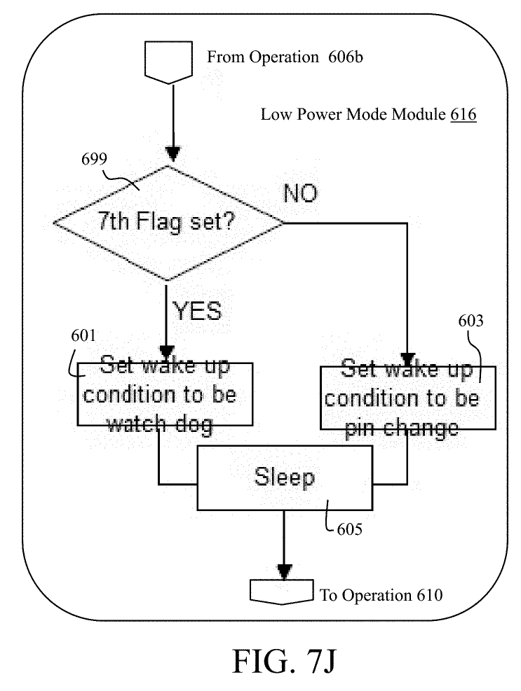

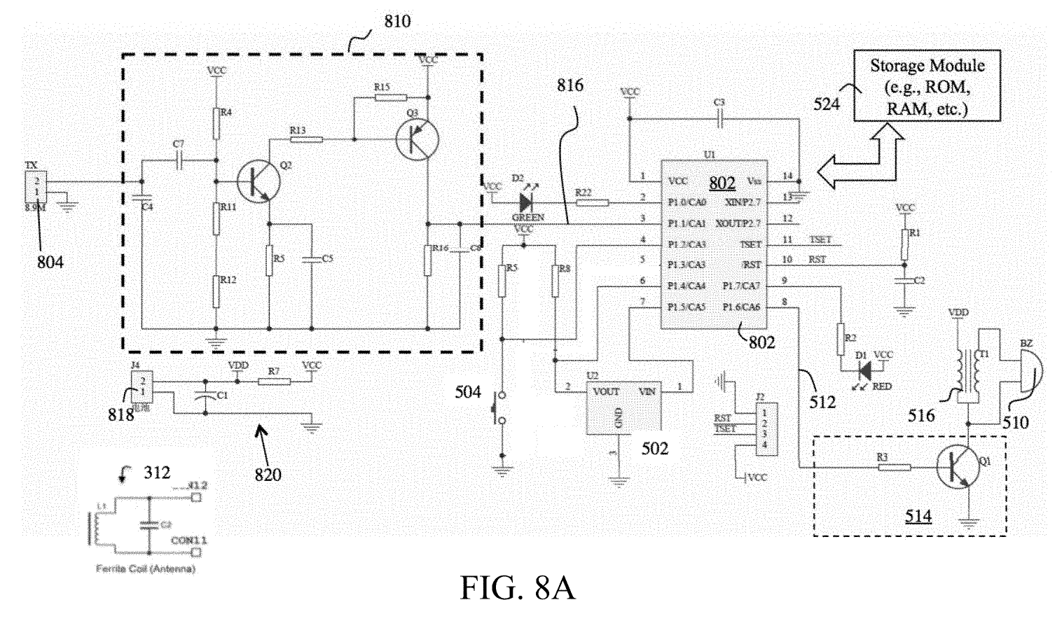

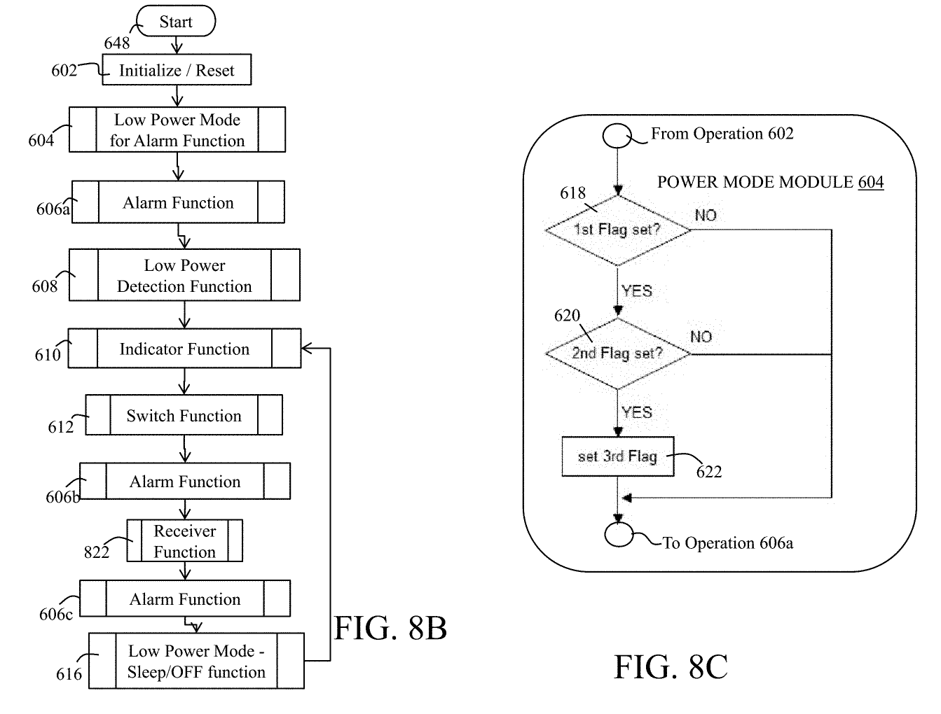

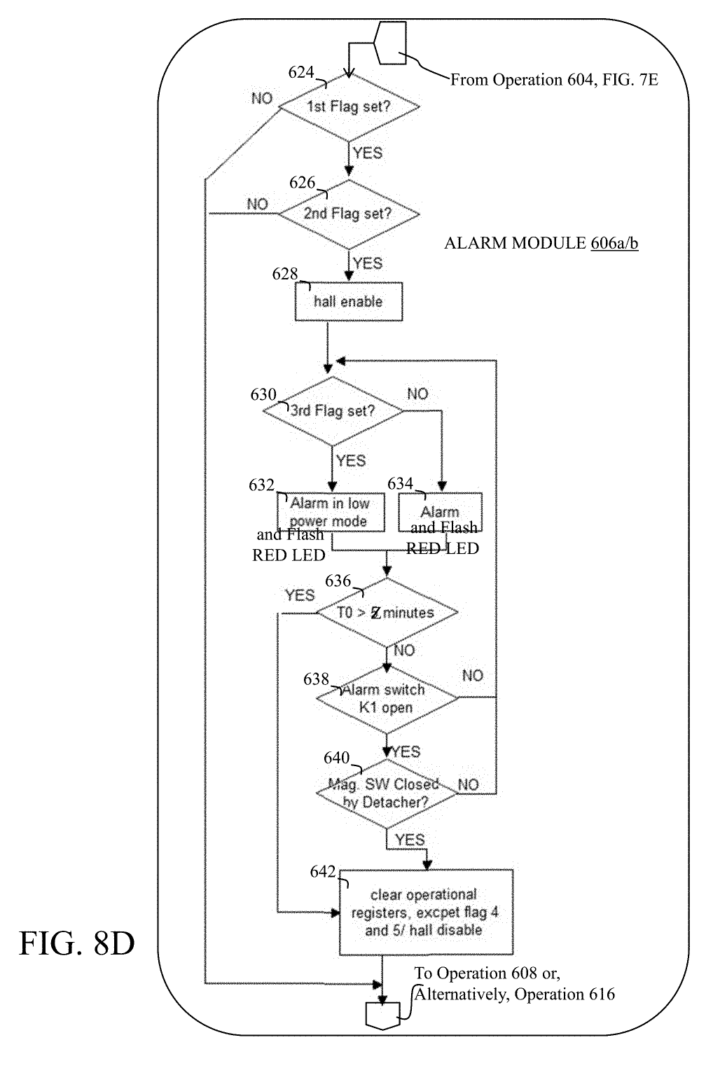

FIGS. 7A to 7J are non-limiting, exemplary illustrations of an EAS alarm tag in accordance with one or more embodiments of the present invention. EAS alarm tag illustrated in FIGS. 7A to 7J includes similar corresponding or equivalent components, interconnections, functional, and or cooperative relationships as EAS alarm tag that is shown in FIGS. 1A to 6G, and described above. Therefore, for the sake of brevity, clarity, convenience, and to avoid duplication, the general description of FIGS. 7A to 7J will not repeat every corresponding or equivalent component, interconnections, functional, operational, and or cooperative relationships that has already been described above in relation to EAS alarm tag that is shown in FIGS. 1A to 6G.

As illustrated in FIGS. 7A to 7J, second member 206 includes a pressure switch actuator 702 that physically contacts and actuates a pressure switch 710 positioned on a PCB within first member 206. Pressure switch 710 allows for a proper exertion of sufficient (or minimum) compression force required to properly engage and arm EAS alarm tag 100 when coupled with article 102 without over exertion of compression force on EAS alarm tag 100 (which may damage article 102) or under exertion where EAS alarm tag 100 may be too loosely engaged with article 102 and may easily fall off. In other words, pressure switch 710 provides a more “tangible” method of determining or indication of “how hard” to press on EAS alarm tag 100 to ensure proper engagement of tag 100 with article 102. In this non-limiting, exemplary instance one or more embodiments of EAS alarm tag 100 may be armed when engaged with article 102 under minimum pressure of about 50 N/m² or so.

As illustrated in FIG. 7A to 7C, pressure switch actuator 702 is comprised of pole that protrudes from a base 708 of second member 206. The pressure switch actuator 702 has a height of length 706 that determines a reach of a free distal end 704 to come into physical contact with and close off pressure switch 710. The longer the length 706 of pressure switch actuator 702, the less pressure it would be required to close pressure switch 710.

An embodiment of the present invention provides pressure switch 710 as a normally open switch and includes a tine portion lanced from flat spring metal strip to form a “leaf” type switch that is moved (from a normal open position) as result of application of compression force exerted by the contacting free distal end 704 of pressure switch actuator 702, which closes pressure switch 710. The tine portion springs back to its default open position when compression force is released. In other words, pressure switch 710 opens immediately when compression force exerted by the pressure switch actuator 702 is removed. That is, during mounting process of EAS alarm tag 100 onto article 102, when retainer 210 is moved to engagement position, a bit of extra pressure may be exerted on the body of EAS alarm tag 100 by a user which compresses and flexes tag 100 sufficiently (due to tag body's flexibility) to allow free distal end 704 of the pressure switch actuator 702 to physically contact and momentarily close pressure switch 710. In other words, to arm EAS alarm tag 100, a momentary closure of pressure switch 710 with continuous closure of alarm switch 504 is required and once armed, the user's release of EAS alarm tag 100 releases pressure on tag body, which, in turn, releases compression force exerted on pressure switch 710, and due to the spring leaf design, pressure switch 710 spring back to open position. Therefore, the closure or opening of pressure switch 710 will not disarm or affect the arming status of EAS alarm tag 100 once the EAS alarm tag 100 has already been armed. Accordingly, as best illustrated in FIG. 7C, in this non-limiting exemplary embodiment, both pressure switch 710 and alarm switch 504 must be closed to arm EAS alarm tag 100 as described above otherwise, EAS alarm tag 100 will not arm. Closing of pressure switch 710 pulls to ground the power voltage VCC at one end via a current limiting resistor R7. When pressure switch 710 is closed, the output of pressure switch 710 is pulled low and set to “0,” and inputted to a second input line 712 of one or more input lines of MCU 508 for arming EAS alarm tag 100. Thereafter, once armed, the pressure switch 702 actually opens immediately when the user release hand-grip pressure on EAS alarm tag 100, but the EAS alarm tag 100 continues to remain armed (due to closed alarm switch 504), and engaged with sufficient strength with article 102.

FIGS. 7D to 7J are non-limiting, exemplary illustration of a flowchart, which amongst other aspects, also illustrate the power management and functionality of MCU 508 for EAS alarm tag 100 in relation to FIG. 7C circuit topography. As indicated above with respect to FIGS. 7A to 7J, for the sake of brevity, clarity, convenience, and to avoid duplication, the general description of FIGS. 7D to 7J will also not repeat every corresponding or equivalent component, interconnections, functional, operational, and or cooperative relationships that has already been described above in relation to EAS alarm tag that is shown in FIGS. 6A to 6G.

As illustrated in FIG. 7A to 7J, this embodiment uses the additional pressure switch 710 and therefore, switch function operations 612 (FIG. 7I) would have to take into consideration the status of pressure switch 710 (and all the other switches) and their conditions (e.g., closed, open, random (or not relevant)), various combinations of which may trigger an alarm, place EAS alarm tag 100 in sleep mode, etc.

In this embodiment, case operation 678 is for the case where both alarm switch 504 and pressure switch 710 are closed, but the condition of the reset switch 502 is not relevant (it may be ON or OFF). Case operation 680 is for the case where alarm switch 504 is closed, pressure switch 710 is open, and the status of the reset switch 502 is again, irrelevant. For case operation 680, EAS alarm tag 100 is not armed as pressure switch 710 never closed (as detailed above). Case operation 682 is for the case where alarm switch 504 is open, the status of the pressure switch 710 (open or closed) is irrelevant, and the reset switch 502 is closed (e.g., by a magnetic detacher). For the case operation 682, all operational registers (or flags) are cleared at operation 692 with the exception of fourth and fifth flags (if they were set). Case operation 682 may generally be processed when EAS alarm tag 100 is properly neutralized by a detacher. Case operation 684 is for the case where alarm switch 504 is open, pressure switch 710 may be open or closed, and the reset switch 502 is open. Accordingly, operations 678 to 684 are different cases for various combinations and permutations of switching activities, with each having different consequences.

Assuming normal operations with no triggered alarm and only alarm switch 504 closed (which caused EAS alarm tag 100 to exit sleep mode operations 605), then case operation 680 for the case where alarm switch 504 is closed, pressure switch 710 is open, and the status of the reset switch 502 is irrelevant is processed. Since this embodiment of EAS alarm tag 100 requires both alarm switch 504 and pressure switch 710 to close to become armed (which is case operation 678), then after processing case operation 680, the MCU 508 powers down (or OFF) the reset switch 502 (if ON). The process flow is transferred to the next operation, which is alarm function operations 606b (as described above).

Continuing with the assumption of normal operations with no triggered alarm and with alarm switch 504 and pressure switch 710 closed (which would cause EAS alarm tag 100 to exit sleep mode operations 605), then case operation 678 for the case where alarm switch 504 is closed, pressure switch 710 is closed, and the status of the reset switch 502 is irrelevant is processed. That is, EAS tag 100 is armed.

Assume now that an unauthorized individual removes EAS alarm tag 100 from an article. That is, EAS alarm tag 100 armed as indicated above, an unauthorized user abruptly pulls or removes EAS alarm tag 100 from an article, which causes alarm switch 504 to open. In this case switch function operations 612 detects a change of status or condition in alarm switch 504. Accordingly, after processing indicator function operations 610 as indicated in the above-described loop, switch function operations 612 are processed. In this case, MCU 508 determines at operation 672 that a switch has a changed or modified status or condition (compared with previous iteration of the same operation, where alarm switch 504 was still closed). Accordingly, since change in switching status or condition of at least one switch (herein alarm switch 504) is detected at operation 672, next operation 674 is processed where MCU 508 powers ON to activate reset switch 502. Thereafter, MCU 508 processes case switch logic operations 676 with different cases (or scenario) operations, which are indicated as case operations 678 to 684. In this non-limiting, exemplary instance, the case operation 684 is selected, which is for the case where alarm switch 504 is open, pressure switch 710 may be open or closed, and the reset switch 502 is open.

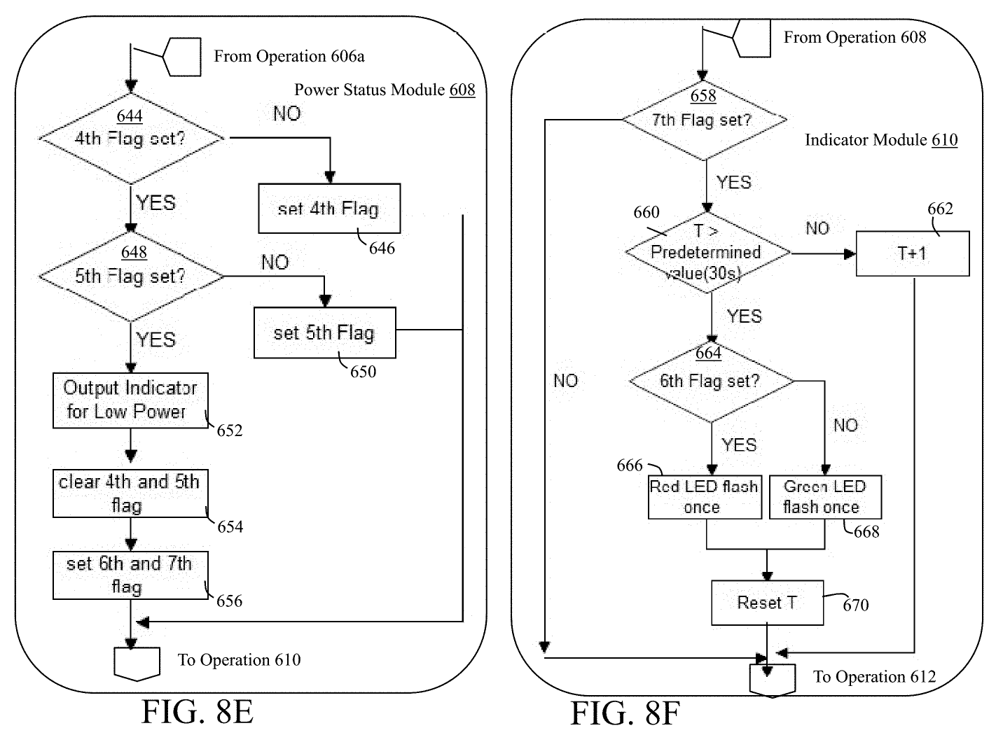

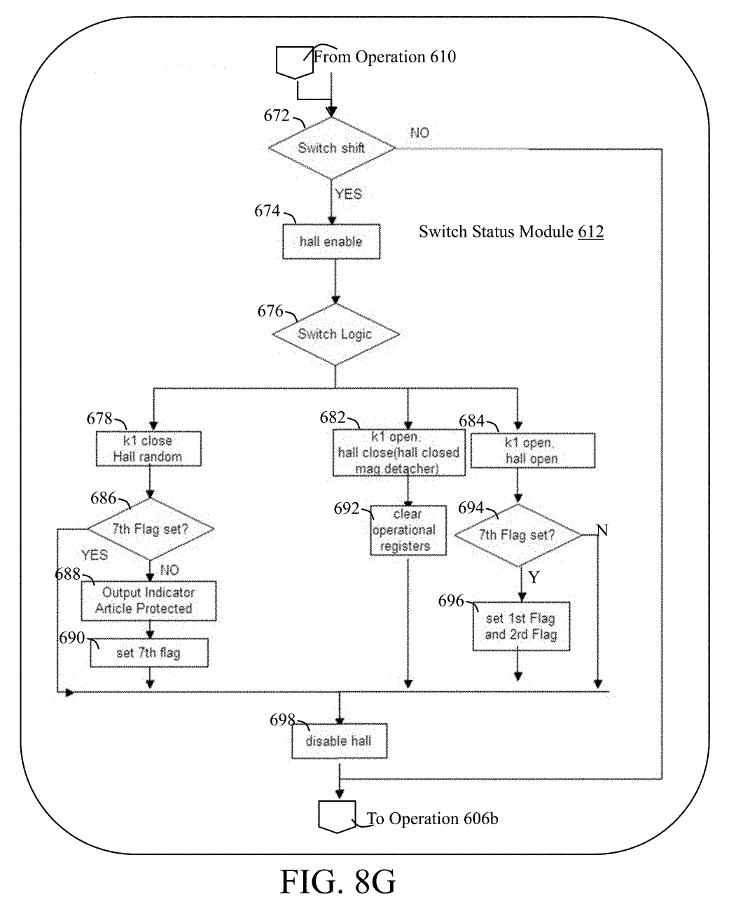

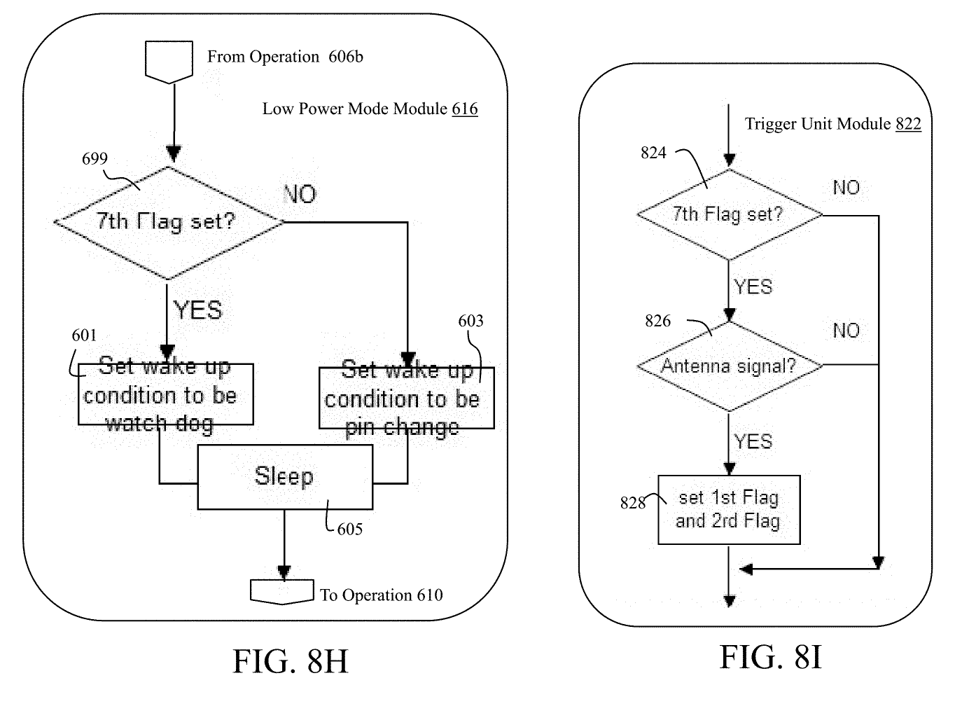

FIGS. 8A to 8I are non-limiting, exemplary illustrations of an EAS alarm tag in accordance with one or more embodiments of the present invention. EAS alarm tag illustrated in FIGS. 8A to 8I include similar corresponding or equivalent components, interconnections, functional, operational, and or cooperative relationships as EAS alarm tag that is shown in FIGS. 1A to 7J, and described above. Therefore, for the sake of brevity, clarity, convenience, and to avoid duplication, the general description of FIGS. 8A to 8I will not repeat every corresponding or equivalent component, interconnections, functional, operational, and or cooperative relationships that has already been described above in relation to EAS alarm tag that is shown in FIGS. 1A to 7J.

As illustrated in FIGS. 8A to 8I, in this non-limiting exemplary instance, the marker 312 is actually wired and connected to MCU 802 via an amplifier 810. MCU 802 is a well-known process (by TEXAS INSTRUMENT TM) mounted onto the PCB with an internal memory 524 (e.g., an EEPROM, ROM, and or a RAM) that includes a set of instructions. MCU 802 receives one or more input signals from one or more input periphery devices and generates one or more processed output signals for actuation of one or more periphery output devices. As with MCU 508, MCU 802 also includes a built-in Power On Reset (POR) functionality.

The processing of data by MCU 802 may include Analog to Digital (A/D) or D/A conversion of signals, and further, each input or pin of MCU 802 may be coupled with various multiplexers to enable processing of several multiple input signals from different input periphery devices with similar processing requirements. Non-limiting examples of one or more input periphery devices may exemplarily include reset switch 502, alarm switch 504, and marker 312, and non-limiting examples of one or more output periphery devices may exemplarily include the use of vibration mechanisms, audio, visual or any other indicators to alarm and notify a user regarding an occurrence. Power and ground connections to the MCU 802 are set forth in accordance with manufacturer specification.

As illustrated, a first output of an EAS connector 804 is coupled with ground GND, and a second output of EAS connector 804 is coupled with amplifier 810 to generate an amplified signal from marker 312. Amplifier 810 increases the signal strength form ferrite unit 312 sufficiently for further processing.

Amplifier 810 is comprised of a current limiting resistor R13 that limits the current input to the base of transistor Q3, with transistor Q3 functioning to amplify the signal (current and voltage) from EAS connector 804. Transistor Q3 is comprised of an exemplary PNP Bipolar Junction Transistors (BJT). It should be noted that present invention should not be limited to the amplifier illustrated, and other conventional amplifiers may also be used. Further, the amplification need not be performed by the BJT, but can be done by other transistors, such as Metal Oxide Semiconductors (MOS) or MOS field effect transistors (MOSFETS), operational amplifiers, transformers, or the like, other passive or active devices, or any combinations thereof.

The amplifier 810 amplifies the output of marker 312, and the amplified signal (from transistor Q3) is input to the MCU 802 via input line 816 as one of one or more input signals, where MCU 802 converts the analog amplified signal into a digital signal for processing. This signal is translated by the instructions (algorithm) within MCU 802 to determine if the signal came from the transmitters (pedestals); if marker signal is received, MCU 802 triggers the alarm (e.g., audio and or visual indicators). It should be noted that one or more of the one or more processed output signals may be pulsed output signals on output line to one of the one or more periphery output devices, for example, for actuation of transducer unit 510 to generate an audio alarm signal as described above.

FIGS. 8B to 8I are non-limiting, exemplary illustrations of flowcharts, which amongst other aspects, also illustrate the power management and functionality of MCU 802 for EAS alarm tag 100 in relation to FIG. 8A circuit topography. As indicated above with respect to FIGS. 8A to 8I, for the sake of brevity, clarity, convenience, and to avoid duplication, the general description of FIGS. 8B to 8I will also not repeat every corresponding or equivalent component, interconnections, functional, operational, and or cooperative relationships that has already been described above in relation to EAS alarm tag that is shown in FIGS. 6A to 6G and 7D to 7J. In particular, the flows illustrated in FIGS. 8B to 8I correspond very closely to flows 6A to 6G where no pressure switch is used, but with the difference of addition of a receiver functionality (or receiver function operations 822) and added alarm function operations 606c.

As indicated in FIG. 8B, receiver function operations 822 enable MCU 802 that receives antenna signals to process and alarm EAS alarm tag 100 somewhat similar to opening alarm switch 504 while EAS alarm tag 100 is armed. Accordingly, as illustrated in FIG. 8I, at operation 824 MCU 802 determines if a seventh flag is set (which is detailed above in relation to FIGS. 6A to 6G and 7D to 7J). Assuming that seventh flag is set, at operation 826 MCU 802 determines if an antenna signal is received and if so, first and second flags are set at operation 828, with process transferred to alarm function operation 606a/b/c (FIG. 8D).

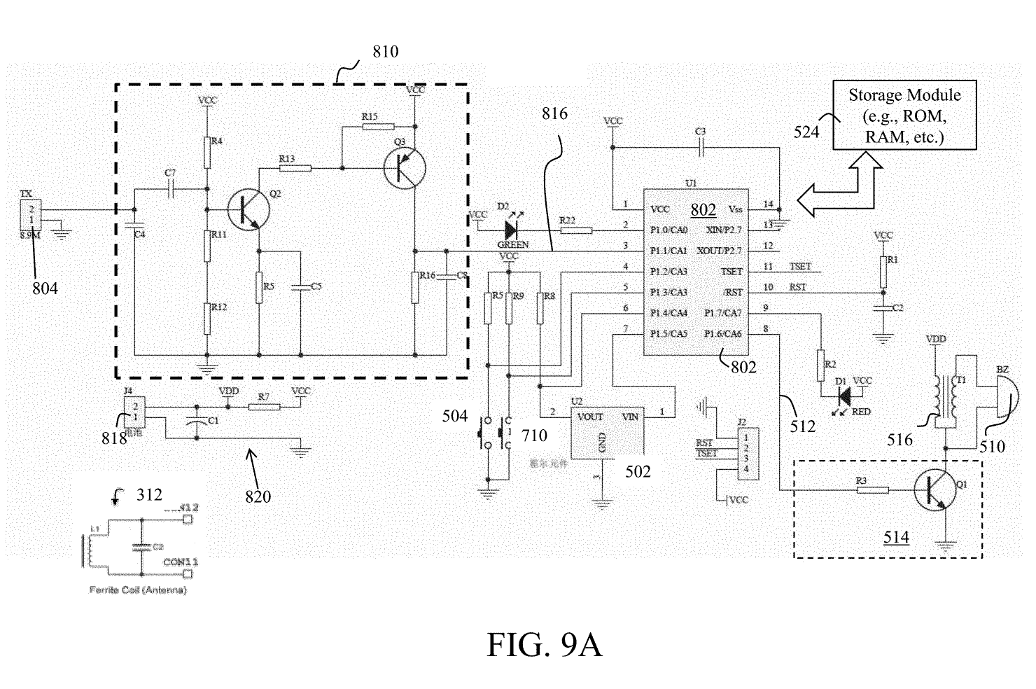

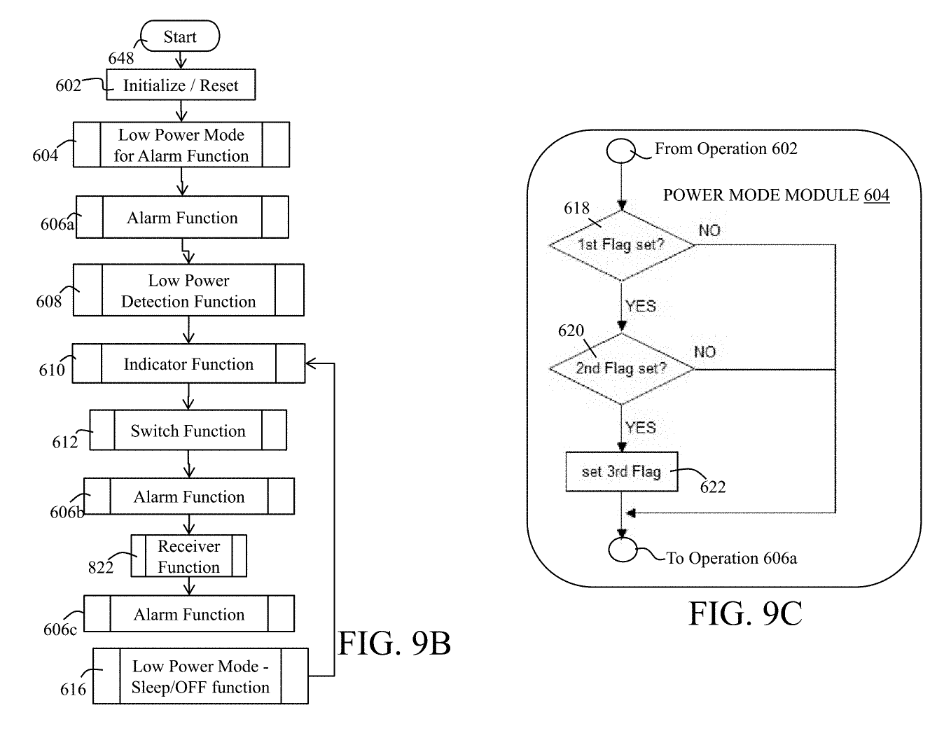

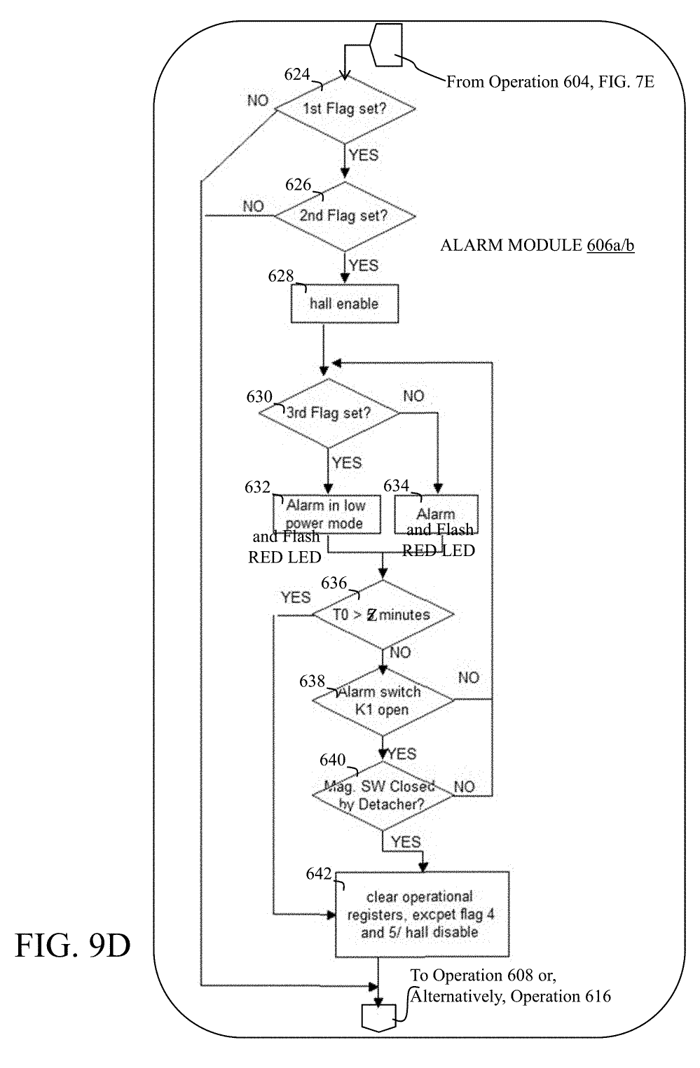

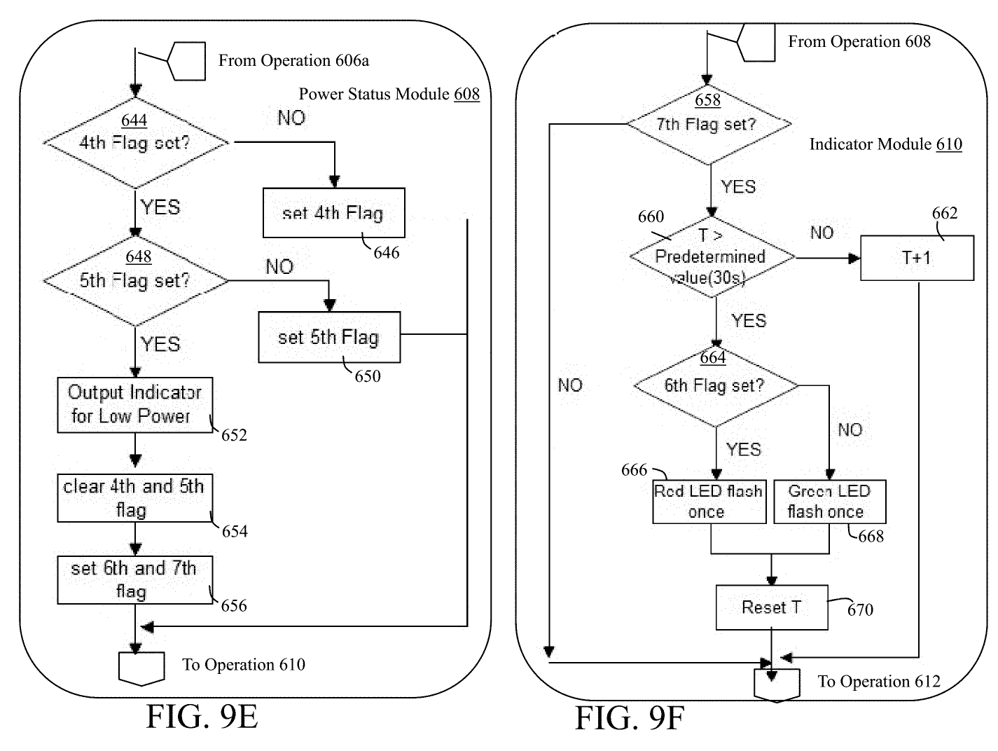

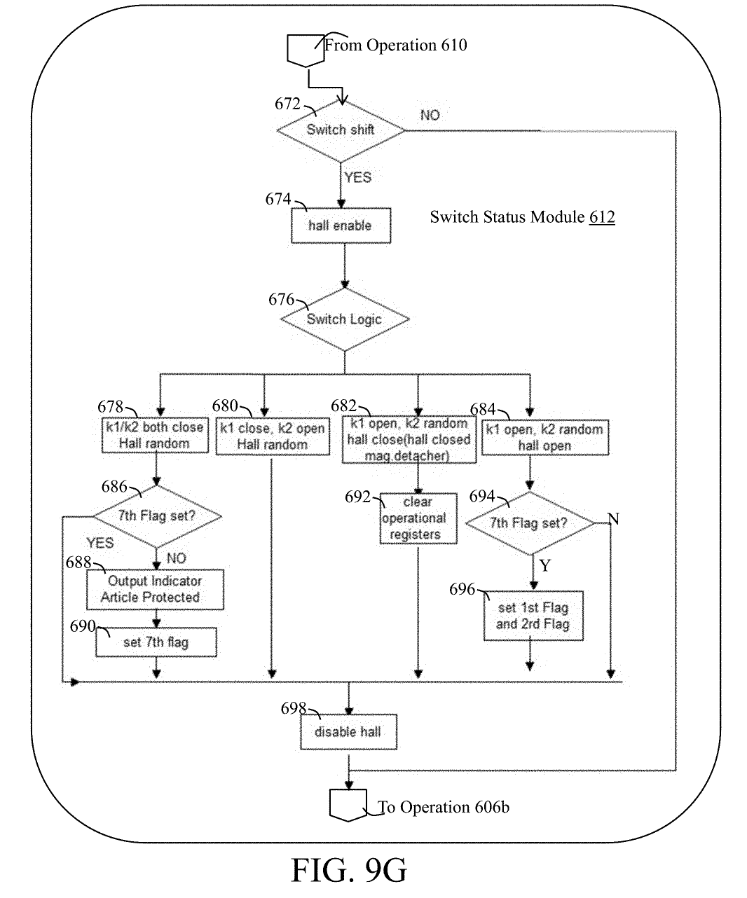

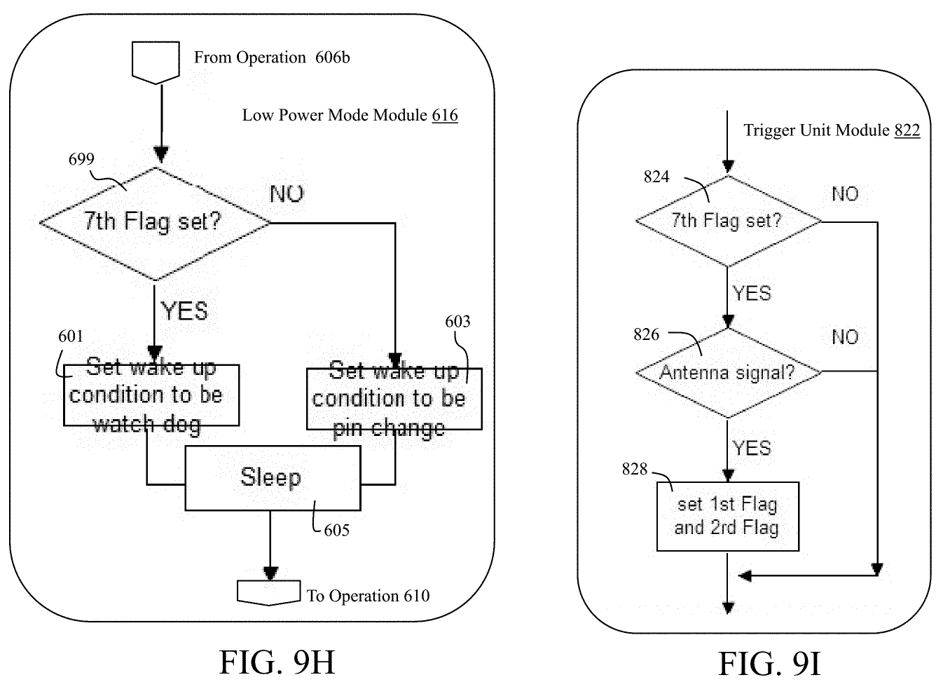

FIGS. 9A to 9I are non-limiting, exemplary illustrations of an EAS alarm tag in accordance with one or more embodiments of the present invention. EAS alarm tag illustrated in FIGS. 9A to 9I include similar corresponding or equivalent components, interconnections, functional, operational, and or cooperative relationships as EAS alarm tag that is shown in FIGS. 1A to 8I, and described above. Therefore, for the sake of brevity, clarity, convenience, and to avoid duplication, the general description of FIGS. 9A to 9I will not repeat every corresponding or equivalent component, interconnections, functional, operational, and or cooperative relationships that has already been described above in relation to EAS alarm tag that is shown in FIGS. 1A to 8I.

Regarding FIG. 9A, the processing of data by MCU 802 may include Analog to Digital (A/D) or D/A conversion of signals, and further, each input or pin of MCU 802 may be coupled with various multiplexers to enable processing of several multiple input signals from different input periphery devices with similar processing requirements. Non-limiting examples of one or more input periphery devices may exemplarily include reset switch 502, alarm switch 504, pressure switch 710, and transponder 312, and non-limiting examples of one or more output periphery devices may exemplarily include the use of vibration mechanisms, audio, visual or any other indicators to alarm and notify a user regarding an occurrence. Power and ground connections to the MCU 802 are set forth in accordance with manufacturer specification.

FIGS. 9B to 9I are non-limiting, exemplary illustrations of flowcharts, which amongst other aspects, also illustrate the power management and functionality of MCU 802 for EAS alarm tag 100 in relation to FIG. 9A circuit topography. As indicated above with respect to FIGS. 9A to 9I, for the sake of brevity, clarity, convenience, and to avoid duplication, the general description of FIGS. 9B to 9I will also not repeat every corresponding or equivalent component, interconnections, functional, operational, and or cooperative relationships that has already been described above in relation to EAS alarm tag that is shown in FIGS. 6A to 6G, 7D to 7J, and 8B to 8I. In particular, the flows illustrated in FIGS. 9B to 9I correspond very closely to flows 7D to 7J and 8B to 8I where pressure switch 710 and antenna receiver function operations 822 are used.

As illustrated in FIG. 9A to 9I, this embodiment uses the additional pressure switch 710 and therefore, switch function operations 612 (FIG. 9G) would have to take into consideration the status of pressure switch 710 (and all the other switches) and their conditions (e.g., closed, open, random (or not relevant)), which is described in detail above in relation to FIGS. 6A to 6G, 7D to 7J, and 8B to 8I.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. Theft-deterrent tag, comprising:
a housing that frictionally engages with an article;
with the frictional engagement having sufficient strength to secure and maintain the housing engaged with the article while having a sufficiently loose hold where the housing is detached and removed from the article without damaging the article.

2. An anti-theft tag, comprising:
a housing;
a retainer associated with the housing and movable to a position for a loose frictional engagement of the anti-theft tag with an article;
with engagement having sufficient strength to secure and maintain the anti-theft tag engaged with the article while having a sufficiently loose hold where the anti-theft tag is detached and removed from the article without damaging the article.

3. An anti-theft tag, comprising:
a housing;
a retainer associated with the housing and movable to a position to frictionally hold the anti-theft tag on an article;
the frictional hold of the retainer has sufficient strength to secure and maintain the anti-theft tag on the article while having a sufficiently loose grip where the anti-theft tag is detached and removed from the article without damaging the article.

4. The anti-theft tag as set forth in claim 3, wherein:
an Electronic Article Surveillance (EAS) module is accommodated within the housing.

5. The anti-theft tag as set forth in claim 4, wherein:
the EAS module triggers an alarm when the anti-theft tag is detached and removed from the article while the EAS module is armed.

6. The anti-theft tag as set forth in claim 3, wherein:
the retainer arms an EAS module when moved to the position while securing the article.

7. The anti-theft tag as set forth in claim 3, wherein:
the retainer and the housing form a gap between which the article is inserted, with a size of the gap defined by the position of the retainer.

8. The anti-theft tag as set forth in claim 3, wherein:
the retainer is comprised of a throw section and a span section.

9. The anti-theft tag as set forth in claim 8, wherein:
the throw section is substantially transverse the span section, with the span section substantially parallel the housing.

10. The anti-theft tag as set forth in claim 8, where:
the span section is moved towards and away from the housing as a result of a portion of the throw section movably extending in and out of the housing along a linear reciprocating path, allowing the span section of the retainer to move closer and further away from the housing to reduce and increase an extent of the gap between the span section of the retainer and the housing.

11. The anti-theft tag as set forth in claim 8, wherein:
the throw section is comprised of:
a first side that includes a first set of serrations that engage a second set of serrations of a lock mechanism to maintain the position of the retainer against a force of a resilient member;
a second side includes a chamber that partially house the resilient member;
the second side further includes a groove extending along a longitudinal axial length of a surface of the second side for accommodating the remaining portion of the resilient member and allowing the resilient member to rest against while the retainer is moved; and
a first and a second lateral surface that include flanges that form stops for preventing the retainer from moving out of the housing as a result of the force of the resilient member.

12. The anti-theft tag as set forth in claim 8, wherein:
the throw section is comprised of:
a first side that accommodates a serrated member that engage lock member of a lock mechanism to maintain the position of the retainer;
a second side includes a chamber that partially house the resilient member;
the second side further includes a groove extending along a longitudinal axial length of a surface of the second side for accommodating the remaining portion of the resilient member and allowing the resilient member to rest against while the retainer is moved; and
a first and a second lateral surface that include flanges that form stops for preventing the retainer from moving out of the housing as a result of the force of the resilient member.

13. The anti-theft tag as set forth in claim 8, wherein:
the span section is comprised of:
a first and a second side; the second side includes a cavity that accommodates an actuator for preventing arming of the EAS module when no article is present and the retainer is at the position.

14. The anti-theft tag as set forth in claim 13, wherein:
the second side of the span section includes padding for improved grip of the retainer and added cushion for preventing damage to the article.

15. The anti-theft tag as set forth in claim 14, wherein:
the padding has a through-hole for allowing passage of the actuator to be accommodated within the cavity of the second side of the span section when no article is present and the retainer is at the position.

16. The anti-theft tag as set forth in claim 8, where:
a first distal end of the span section and a first distal end of the throw section form a bend of the retainer;
with a second distal end of the span section and the second distal end of the throw section free.

17. The anti-theft tag as set forth in claim 16 where:
the second distal end of the throw section is accommodate within the housing, through a first opening and is aligned to substantially perpendicularly extend in and out of the housing by a set of guide structures.

18. The anti-theft tag as set forth in claim 3, where:
the housing is comprised of a first member and a second member.

19. The anti-theft tag as set forth in claim 18, where:
the first member includes a perforated area that forms a grill-openings for facilitating an output of an audio indicator sound.

20. The anti-theft tag as set forth in claim 18, where:
the first member includes a visual indicator aperture for viewing of a visual indicator device.

21. The anti-theft tag as set forth in claim 18, where:
the first member includes:
a cavity that accommodates the EAS module, including a maker;
the cavity further includes:
a set of guide structures that substantially aligned a throw-section of the retainer to perpendicularly extend in and out of the housing to maintain an orientation of the throw-section while being articulated;
Visual indicator housing for securing an LED within the housing;
biasing support configured as a cylindrical pole for maintaining a mounted resilient member of the retainer;
transducer compartment for securing an audio transducer;
marker section for securing the marker within the housing; and
lock mechanism housing.

22. The anti-theft tag as set forth in claim 18, where:
the second member includes:
actuator aperture that enables an actuator to pass through;
hinge barrel for coupling a hinge pin of the actuator;
retainer aperture configured commensurate with the profile portion of the throw section that includes the chamber for the biasing mechanism;
concaved curved cut-out section at side for accommodating the lock mechanism housing for when mating with the first member.

23. The anti-theft tag as set forth in claim 4, wherein:
the EAS module includes:
a first switch for resetting an alarm system of the alarm tag to OFF;
a second switch to set the alarm;
a triggering unit that senses and detects surveillance signals to generate a detected surveillance signal that triggers one of an external alarm or the alarm;
when the anti-theft tag is secured onto an article and the second switch is closed the alarm system of the alarm tag is armed and set to ON; and
when the anti-theft tag is detached and removed from the article while the anti-theft tag is armed, an alarm system of the alarm tag activates an alarm.

24. The anti-theft tag as set forth in claim 23, wherein:
the second switch is actuated by the actuator.

25. The anti-theft tag as set forth in claim 23, wherein:
the EAS module further includes a pressure switch that in combination with the second switch arms the EAS module when both the pressure switch and second switch are closed.

26. The anti-theft tag as set forth in claim 25, wherein:
the pressure switch is actuated by a pressure switch actuator.

27. The anti-theft tag as set forth in claim 26, wherein:
the pressure switch actuator is comprised of pole that protrudes from a base of second member.

28. The anti-theft tag as set forth in claim 23, wherein:
the EAS module further includes:
a Microcontroller unit (MCU) for processing of one or more input signals from one or more input devices and output of one or more output signals to actuate one or more output devices.

29. The anti-theft tag as set forth in claim 4, wherein:
the EAS module includes a Microcontroller unit (MCU) for processing of one or more input signals from one or more input devices and generating of one or more output signals to actuate one or more output devices;
wherein: when a power level to MCU drops below a minimum threshold, MCU resets.

30. The anti-theft tag as set forth in claim 29, wherein:
EAS module is operated in low power mode when MCU is rest due to low power.

31. A system for alarming and power management for an Electronic Article Surveillance (EAS) alarm tag, comprising:
a power mode module that functions to enable a Microcontroller unit (MCU) to determine if an alarm module is to operate at a low power mode;
the alarm module functions to enable MCU to operate an alarm in one of normal or low power modes;
a power status module that functions to enable MCU to determine power status of a power source of the EAS tag;
an indicator module that functions to enable MCU to operate one or more indicators;
a switch status module enables MCU to operate one or more functions of EAS tag based on statuses of one or more switches;
a trigger unit module that functions to enable MCU to determine if EAS tag is within an interrogation zone of an EAS system; and
a low power mode module that functions to enable MCU to enter sleep mode.

32. The system for alarming and power management for an Electronic Article Surveillance (EAS) alarm tag as set forth in claim 31, wherein:
the alarm module operates at the low power mode when MCU is reset due to low power caused by extended triggered alarm.

33. The system for alarming and power management for an Electronic Article Surveillance (EAS) alarm tag as set forth in claim 31, wherein:
MCU includes a power on reset operation that enables MCU to reset when power drops below threshold level.

34. The system for alarming and power management for an Electronic Article Surveillance (EAS) alarm tag as set forth in claim 31, wherein:
the alarm triggered in one of normal or low power modes has a duration of time T.

35. The system for alarming and power management for an Electronic Article Surveillance (EAS) alarm tag as set forth in claim 31, wherein:
a power status of the power source of the EAS tag if low, enables the indicator module to operate one or more low power indicators and if normal, enables the indicator module to operate one or more normal power indicators.

36. The system for alarming and power management for an Electronic Article Surveillance (EAS) alarm tag as set forth in claim 31, wherein:
the indicator module operates one or more indicators at predetermined time intervals.

37. The system for alarming and power management for an Electronic Article Surveillance (EAS) alarm tag as set forth in claim 31, wherein:
the switch status module tracks operating status of one or more switches of the EAS alarm tag to arm the EAS tag, trigger alarm, reset EAS tag, or enable power mode module.

38. The system for alarming and power management for an Electronic Article Surveillance (EAS) alarm tag as set forth in claim 31, wherein:
the trigger unit module is comprised of a marker that responds to interrogation signals of the EAS system when the EAS tag is within the interrogation zone.

39. The system for alarming and power management for an Electronic Article Surveillance (EAS) alarm tag as set forth in claim 31, wherein:
the EAS tag exits sleep mode based on one or more criteria.

40. The system for alarming and power management for an Electronic Article Surveillance (EAS) alarm tag as set forth in claim 31, wherein:
the one or more criteria include one of a change in port status of MCU or a watchdog timer.

41. A method for alarming and power management for an Electronic Article Surveillance (EAS) alarm tag, comprising:
determining if there is a status change in one or more switches;
if there is a status change in one or more switches, determining if a current status of an alarm switch of one or more switches is closed and if so, arming the EAS alarm tag and outputting an indicator signal that article is protected;
if the current status of the alarm switch is open, and a current status of a reset switch of one or more switches is closed, resetting EAS alarm tag; and
if the current status of the alarm switch is open and the current status of the reset switch is open, triggering an alarm.

42. The method for alarming and power management for an Electronic Article Surveillance (EAS) alarm tag as set forth in claim 41, further comprising:
arming the EAS alarm tag and outputting the indicator signal that article is protected if current statues of both the alarm switch and a pressure switch are determined closed.

43. The method for alarming and power management for an Electronic Article Surveillance (EAS) alarm tag as set forth in claim 41, further comprising:
determining if an antenna signal is received for triggering the alarm.

44. The method for alarming and power management for an Electronic Article Surveillance (EAS) alarm tag as set forth in claim 41, comprising:
triggering the alarm in low power mode when EAS alarm tag is reset due to low power caused by extended triggered alarm.

45. The method for alarming and power management for an Electronic Article Surveillance (EAS) alarm tag as set forth in claim 41, comprising:
entering sleep mode after a predetermined elapsed time, and exiting sleep mode based on one or more criteria.

46. The method for alarming and power management for an Electronic Article Surveillance (EAS) alarm tag as set forth in claim 45, wherein:
the one or more criteria include one of a change in port status of a Microcontroller unit (MCU) or a watchdog timer.

47. An anti-theft tag, comprising:
the lock mechanism that includes:
a first member that is comprise of a metal that transfers a magnetic force to second member to unlock the second member from a third member.

48. The anti-theft tag as set forth in claim 47, wherein:
the first member is comprised of metallic member.

49. The anti-theft tag as set forth in claim 47, wherein:
the second member is a lock member comprised of:
a base and a distal end flange in a form of a hook that engages the third member.

50. The anti-theft tag as set forth in claim 47, wherein:
the second member is a lock member comprised of a tine that is lanced from a strip of material, with a distal end of the tine having a flange in a form of a hook that engages the third member.

51. The anti-theft tag as set forth in claim 47, wherein:
the third member is a comprised of serrations that receives the second member.
